(19) United States
(12) Patent Application Publication
(10) Pub. No.: US 2026/0287561 A1
(43) Pub. Date: Sep. 24, 2026

(54) PHYTOFUNCTIONAL COMPOSITIONS

(71) Applicants: Grant Andrew Krause, Rochester Hills, MI (US); Andrew Harold Krause, Rochester Hills, MI (US)

(72) Inventors: Grant Andrew Krause, Rochester Hills, MI (US); Andrew Harold Krause, Rochester Hills, MI (US)

(21) Appl. No.: 19/692,728

(22) Filed: May 29, 2026

Related U.S. Application Data
(63) Continuation of application No. 17/222,943, filed on Apr. 5, 2021.

(51) Int. Cl. G01N 30/06; B01D 11/02; G01N 30/02

(52) U.S. Cl. CPC G01N 30/06; B01D 11/0284; B01D 11/0288; B01D 11/0292; G01N 2030/022; G01N 2030/062; G01N 2030/065

(57) ABSTRACT

A cGMP-compatible phytofunctional composition formed from a cannabis source or a hemp source is disclosed. The phytofunctional composition comprises a plurality of native organic acids and one or more native terpenes obtained from the cannabis source or hemp source. One or more ratios between the native organic acids present in the cannabis source or hemp source and corresponding ratios present in the phytofunctional composition are substantially similar. One or more source-linked cannabinoid profiles, cannabinoid-acid profiles, terpene profiles, chromatographic profiles, spectroscopic profiles, volatile profiles, or combinations thereof are preserved within a selected analytical tolerance. The phytofunctional composition is substantially free of degradation-generated neutral cannabinoids, decarboxylated byproducts, microbial contamination, mold, mildew, fungus, pesticides, heavy metals, residual solvents, exogenous cannabinoids, exogenous terpenes, isolate spikes, diluents, carrier oils, reconstructed profile markers, or combinations thereof.

### CROSS-REFERENCE TO RELATED APPLICATIONS

This application claims the benefit of and priority to U.S. patent application Ser. No. 17/222,943, filed Apr. 5, 2021, published as U.S. Patent Application Publication No. 2022/0317097 A1 on Oct. 6, 2022, entitled “Atmospheric Triphasic Chromatography (ATC) Method,” the entire disclosure of which is hereby expressly incorporated herein by reference in its entirety for all purposes.

### FIELD OF THE INVENTION

The present invention relates generally to cannabis-derived compositions, hemp-derived compositions, cannabinoid-containing plant compositions, and analytically verified phytofunctional compositions and, more specifically, to cGMP-compatible cannabis and hemp compositions that preserve one or more native or source-linked chemical fingerprint characteristics while being substantially free of pre-consumer adulteration, degradation, contamination, and reconstitution markers.

### BACKGROUND OF THE INVENTION

Cannabis and hemp materials can contain complex native chemical profiles comprising cannabinoid acids, neutral cannabinoids, terpenes, volatile constituents, flavonoids, phenolics, organic acids, and other chemically sensitive phytofunctional constituents. Such native profiles may vary substantially depending on cultivar, chemotype, harvest timing, plant part, growing environment, drying conditions, curing conditions, storage conditions, microbial exposure, and post-harvest handling. In many instances, native cannabinoid-acid profiles and terpene profiles can degrade, decarboxylate, oxidize, decompose, volatilize, or otherwise transform during extraction, drying, formulation, storage, transportation, remediation, sterilization, or downstream processing. For example, native cannabinoid acids such as tetrahydrocannabinolic acid (THCa), cannabidiolic acid (CBDa), cannabigerolic acid (CBGa), cannabichromenic acid (CBCa), tetrahydrocannabivarinic acid (THCVa), cannabidivarinic acid (CBDVa), and cannabinolic acid (CBNa) can undergo unintended pre-consumer decarboxylation into corresponding neutral cannabinoids including THC, CBD, CBG, CBC, THCV, CBDV, and CBN. Likewise, volatile terpene constituents can degrade, oxidize, evaporate, or otherwise transform during processing and storage, thereby altering the source-linked chemical identity of the original cannabis or hemp material.

Conventional purification, decontamination, remediation, extraction, and stabilization processes often fail to preserve the native chemical relationships originally present in cannabis and hemp source materials. Heat exposure, extended drying, irradiation, solvent washing, oxidative treatment, aggressive filtration, and other intrusive remediation techniques can reduce microbial burden or contaminant levels while simultaneously causing terpene loss, cannabinoid-acid degradation, oxidation, decomposition, isomerization, profile stripping, or unintended decarboxylation. In addition, some commercially available cannabis and hemp products are produced through profile reconstruction techniques involving isolate spiking, terpene supplementation, dilution, flavor enhancement, re-terpenation, or addition of exogenous cannabinoids, exogenous terpenes, carrier oils, diluents, masking agents, or foreign botanical constituents. While such reconstructed products may satisfy selected potency targets or sensory characteristics, they often fail to preserve the native source-linked chemical fingerprint relationships associated with the original cannabis or hemp source material. As a result, conventional cannabis and hemp compositions can become analytically distinguishable from their originating plant source due to degradation, contamination, adulteration, or artificial reconstruction.

In regulated or anticipated regulated cannabis and hemp manufacturing environments, manufacturers may be required to satisfy increasingly rigorous cGMP-oriented quality-control, contamination-control, identity, purity, potency, traceability, and batch-release requirements. Such requirements can include limits on microbial contamination, mold, mildew, fungal contamination, spores, mycotoxin-associated markers, aflatoxin-associated markers, pesticides, heavy metals, residual solvents, degradation-generated neutral cannabinoids, and other pre-consumer adulteration markers. However, conventional remediation and contaminant-reduction processes can themselves damage native cannabinoid-acid profiles, terpene profiles, volatile constituent profiles, and other source-linked chemical relationships. Accordingly, there is a need for cannabis-derived and hemp-derived phytofunctional compositions that preserve native or source-linked cannabinoid, cannabinoid-acid, terpene, volatile, chromatographic, spectroscopic, and multivariate analytical fingerprint characteristics while simultaneously being substantially free of degradation markers, contamination markers, adulteration markers, exogenous reconstruction markers, and other pre-consumer exclusion markers associated with chemically altered, remediated, diluted, reconstructed, or adulterated cannabis and hemp materials.

### SUMMARY OF THE INVENTION

A cGMP-compatible phytofunctional composition formed from a cannabis source or a hemp source is disclosed. The phytofunctional composition comprises a plurality of native organic acids and one or more native terpenes obtained from the cannabis source or hemp source. One or more ratios between the plurality of native organic acids present in the cannabis source or hemp source and corresponding ratios present in the phytofunctional composition are substantially similar. The phytofunctional composition preserves one or more source-linked cannabinoid profiles, cannabinoid-acid profiles, terpene profiles, chromatographic profiles, spectroscopic profiles, volatile profiles, or combinations thereof within a selected analytical tolerance. The phytofunctional composition is substantially free of degradation-generated neutral cannabinoids, decarboxylated byproducts, microbial contamination, mold, mildew, fungus, pesticides, heavy metals, residual solvents, exogenous cannabinoids, exogenous terpenes, isolate spikes, diluents, carrier oils, reconstructed profile markers, or combinations thereof.

In many embodiments, the disclosed phytofunctional composition selectively preserves source-linked cannabinoid-acid relationships, terpene relationships, volatile profiles, chromatographic profiles, spectroscopic profiles, or combinations thereof while simultaneously reducing, eliminating, or controlling degradation-generated constituents, contamination markers, adulteration markers, reconstruction markers, or other exclusion markers associated with naturally occurring source material or downstream processing. As a result, the disclosed phytofunctional composition can possess analytically verifiable characteristics distinct from naturally occurring cannabis-derived or hemp-derived source material and conventionally remediated, purified, reconstructed, adulterated, diluted, or artificially reformulated cannabis-derived or hemp-derived materials.

A cGMP-compatible consumption-safe composition is also disclosed. The composition comprises a plurality of native organic acids and one or more native terpenes obtained from a cannabis source or a hemp source together with a consumption-safe carrier, medium, matrix, solvent, excipient, formulation base, or combinations thereof. One or more source-linked analytical relationships associated with the cannabis source or hemp source are preserved within a selected analytical tolerance while the composition remains substantially free of degradation-generated neutral cannabinoids, contamination markers, adulteration markers, reconstruction markers, or combinations thereof. In some embodiments, the composition is configured as a formulation-ready composition, compounding composition, cGMP-compatible intermediate composition, downstream manufacturing composition, or incorporation-ready composition suitable for incorporation into capsules, tablets, beverages, powders, suspensions, solutions, emulsions, ingestible products, inhalable products, topical products, oral products, or combinations thereof. In other embodiments, the composition preserves one or more native acidic cannabinoid profiles while remaining substantially free of degradation-generated neutral cannabinoids above a selected threshold.

A method of characterizing or releasing a cGMP-compatible phytofunctional composition formed from a cannabis source or a hemp source is also disclosed. The method comprises obtaining source-fingerprint data from an identifiable cannabis source or hemp source and obtaining output-fingerprint data from a resulting phytofunctional composition. The method also comprises comparing the source-fingerprint data and the output-fingerprint data to determine preservation of one or more source-linked cannabinoid profiles, cannabinoid-acid profiles, terpene profiles, volatile profiles, chromatographic profiles, spectroscopic profiles, or combinations thereof. The method further comprises testing the resulting phytofunctional composition for one or more degradation markers, microbial contaminants, fungal contaminants, pesticide residues, heavy metals, residual solvents, exogenous terpenes, exogenous cannabinoids, isolate spikes, or reconstructed profile markers, and designating the resulting phytofunctional composition as a cGMP-compatible release-state phytofunctional composition only when one or more source-linked profiles are preserved within a selected analytical tolerance and one or more exclusion criteria are satisfied.

The transitional phrase “consisting essentially of” limits the claimed and described phytofunctional composition to components that do not materially affect the basic and novel characteristics of the phytofunctional composition. As used herein, the term “materially affect” means to alter the intended purpose, performance, analytical identity, source-linked fingerprint preservation, contaminant exclusion profile, or fundamental function of the invention in a meaningful way.

As used herein, the phrase “substantially similar,” with respect to one or more ratios, profiles, fingerprints, analytical characteristics, or source-linked constituents, means that one or more corresponding characteristics of the phytofunctional composition remain within a selected analytical tolerance relative to the cannabis source or hemp source. As used herein, the phrase “selected analytical tolerance” refers to a predetermined analytical acceptance criterion, threshold, range, or deviation limit chosen by the practitioner, manufacturer, or regulatory authority based on the intended use, product category, species, cultivar, chemotype, processing method, analytical method, or regulatory requirements associated with the cannabis source or hemp source and the resulting phytofunctional composition. In some embodiments, the selected analytical tolerance comprises a percent deviation of less than about 50 percent, 45 percent, 40 percent, 35 percent, 30 percent, 25 percent, 20 percent, 15 percent, 10 percent, 5 percent, 2 percent, 1 percent, 0.5 percent, or 0.1 percent relative to one or more source-linked analytical characteristics. In other embodiments, the selected analytical tolerance comprises a multivariate similarity score of at least about 0.80, 0.85, 0.90, 0.95, or greater. In still other embodiments, the selected analytical tolerance comprises a chromatographic correlation, spectral similarity, ratio drift threshold, set-membership criterion, or principal-component similarity criterion. All individual values, analytical thresholds, tolerances, deviations, percentages, similarity scores, and subranges within the foregoing ranges are expressly contemplated. In some embodiments, substantial similarity is determined using percent deviation, ratio drift, chromatographic correlation, spectral similarity, multivariate similarity, principal-component similarity, set-membership preservation, or combinations thereof. In some embodiments, one or more source-to-output ratios differ by less than about 20 percent, 15 percent, 10 percent, 5 percent, 2 percent, or 1 percent relative to the cannabis source or hemp source. In other embodiments, substantial similarity is determined by preservation of one or more cannabinoid-acid profiles, terpene profiles, volatile profiles, chromatographic profiles, spectroscopic profiles, or combinations thereof within a selected analytical tolerance.

As one example, the phytofunctional composition consisting essentially of the plurality of native organic acids and the one or more native terpenes includes less than 20, 15, 10, 9, 8, 7, 6, 5, 4, 3, 2, or 1 percent by weight additional components, based on 100 parts by weight of the phytofunctional composition. As another example, the phytofunctional composition consisting essentially of cannabis-derived or hemp-derived native constituents includes less than 20, 15, 10, 9, 8, 7, 6, 5, 4, 3, 2, or 1 percent by weight exogenous cannabinoids, exogenous terpenes, isolate spikes, diluents, carrier oils, masking agents, reconstructed profile components, or combinations thereof, based on 100 parts by weight of the phytofunctional composition. In contrast, the phrase “consisting of” is closed-ended and excludes any element, step, or feature not specifically recited. Unless otherwise stated, these transitional phrases are to be interpreted in accordance with these definitions.

Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or incorporated into the enumerated steps or components.

### BRIEF DESCRIPTION OF THE DRAWINGS

FIG. 1 is a representative decarboxylation reaction diagram illustrating the thermal conversion of tetrahydrocannabinolic acid (THCa) to delta-9-tetrahydrocannabinol (49-THC).

FIG. 2 is a representative comparative cannabinoid profile illustrating source flower cannabinoid-acid distribution and Example 1 cannabinoid-acid distribution.

FIG. 2A is a lab testing result showing a representative comparative cannabinoid profile illustrating source flower cannabinoid-acid distribution and Example 1 cannabinoid-acid distribution.

FIG. 3 is a representative analytical framework illustrating selective preservation of source-linked native chemistry and selective exclusion of naturally co-occurring degradation, contamination, and adulteration markers to produce a composition state possessing markedly different characteristics from naturally occurring source material.

FIG. 4 is a representative comparison between flash decarboxylation and processing-associated lab decarboxylation.

### DETAILED DESCRIPTION OF THE CURRENT EMBODIMENTS

A cGMP-compatible phytofunctional composition of this disclosure is useful in preserving native or source-linked chemical fingerprint characteristics associated with cannabis-derived and hemp-derived materials while simultaneously reducing or eliminating contamination markers, degradation markers, adulteration markers, and reconstruction markers associated with conventional processing techniques. The phytofunctional composition includes a plurality of native organic acids and one or more native terpenes obtained from a cannabis source or a hemp source. The disclosed compositions are configured to preserve source-linked cannabinoid-acid relationships, terpene relationships, chromatographic profiles, spectroscopic profiles, volatile profiles, or combinations thereof within selected analytical tolerances.

In many embodiments, the disclosed phytofunctional composition resolves a technical incompatibility associated with conventional cannabis and hemp processing. Processing conditions capable of reducing microbial contamination, fungal contamination, pesticide residues, residual solvents, degradation markers, or other exclusion markers can simultaneously damage chemically sensitive native constituents including cannabinoid acids, terpene relationships, volatile profiles, chromatographic signatures, spectroscopic signatures, or other source-linked analytical characteristics. For example, heat exposure, irradiation, aggressive remediation, oxidative treatment, prolonged drying, sterilization, filtration, solvent washing, or extended storage can reduce contamination or adulteration markers while simultaneously causing decarboxylation, oxidation, volatilization, decomposition, profile stripping, or analytical drift associated with native cannabinoid-acid relationships and volatile terpene relationships. Conversely, untreated cannabis-derived or hemp-derived source material can retain native source-linked analytical relationships while also containing naturally occurring degradation products, partially decarboxylated cannabinoids, oxidation products, microbial contaminants, pesticides, heavy metals, residual solvents, or other exclusion markers associated with harvesting, curing, transportation, storage, environmental exposure, or downstream processing.

In many embodiments, the disclosed phytofunctional composition selectively preserves source-linked native analytical relationships while simultaneously reducing, eliminating, or controlling naturally occurring and process-generated exclusion markers. Such selectively preserved analytical relationships can include cannabinoid-acid ratios, acid-to-neutral cannabinoid relationships, terpene ratios, volatile constituent profiles, chromatographic signatures, spectroscopic signatures, mass spectrometric patterns, multivariate analytical relationships, or combinations thereof associated with the original cannabis source or hemp source. Simultaneously, the disclosed phytofunctional composition can exhibit reduced levels of degradation-generated neutral cannabinoids, oxidation products, decomposition products, microbial contaminants, fungal contaminants, mycotoxin-associated markers, pesticide residues, heavy metals, residual solvents, exogenous constituents, isolate spikes, reconstructed profile markers, or other exclusion markers relative to untreated source material, conventionally remediated material, purified material, or reconstructed cannabis-derived or hemp-derived formulations. In many embodiments, simultaneous preservation of unstable native chemistry and exclusion of degradation or contamination markers can reduce analytical drift while maintaining source-linked chemical identity associated with the original cannabis source or hemp source.

In many embodiments, the disclosed phytofunctional composition therefore represents a selectively preserved and selectively excluded analytical composition state that does not naturally occur in untreated cannabis-derived or hemp-derived source material. Unlike naturally occurring source material, which can inherently contain degradation-generated neutral cannabinoids, oxidized constituents, partially decarboxylated cannabinoid acids, microbial contamination, fungal contamination, pesticides, heavy metals, residual solvents, or other exclusion markers, the disclosed phytofunctional composition preserves selected source-linked analytical relationships while simultaneously reducing or eliminating such exclusion markers. In many embodiments, the disclosed phytofunctional composition is therefore analytically distinguishable from naturally occurring biomass, ordinary extracts, purified isolates, destructively remediated material, infused material, sprayed biomass, diluted formulations, re-terpenated products, isolate-spiked products, or artificially reconstructed cannabis-derived or hemp-derived materials and represents a cGMP-compatible release-state composition possessing analytically verifiable characteristics distinct from both naturally occurring source material and conventionally processed materials. Such analytically verifiable distinctions can support cGMP-compatible release-state characterization, analytical verification, contamination control, anti-reconstitution verification, traceability, and regulated cannabis and hemp manufacturing.

For example, tetrahydrocannabinolic acid (THCa) and tetrahydrocannabinol (THC) are chemically related cannabinoid constituents that differ in both structure and functional properties. THCa is the acidic precursor to THC and is naturally present in raw, freshly harvested, or minimally processed cannabis material. In many embodiments, THCa functions as a native source-linked cannabinoid acid associated with the original cannabis source. THCa is generally non-psychoactive because the molecule contains a carboxyl group that limits interaction with cannabinoid receptors associated with psychoactive activity. Upon exposure to heat, oxidation, aging, combustion, vaporization, cooking, drying, remediation, transportation, storage, or other processing conditions, THCa can undergo decarboxylation, whereby the molecule loses a carboxyl group (COOH) and converts into THC. THC is psychoactive and can alter mood, perception, appetite, cognition, or sensory response through interaction with the endocannabinoid system. In many embodiments, unintended pre-consumer conversion of THCa into THC functions as a degradation marker, decarboxylation marker, transformation marker, or analytical indicator of source-linked profile alteration. Over time, THC itself can further oxidize or degrade into cannabinol (CBN), which can function as an additional degradation-associated marker indicative of aging, oxidation, storage instability, or excessive thermal exposure. Preservation of native THCa profiles while reducing unintended formation of THC and CBN can therefore maintain source-linked chemical identity and reduce profile drift associated with degradation or remediation processes.

As described above with respect to paragraph [0021], the disclosed phytofunctional composition is materially distinct from naturally occurring cannabis-derived or hemp-derived source material because the disclosed composition simultaneously preserves selected source-linked analytical relationships while reducing, eliminating, or controlling one or more exclusion markers associated with degradation, contamination, adulteration, remediation, supplementation, reconstruction, or downstream processing. In many embodiments, the disclosed phytofunctional composition therefore represents a cGMP-compatible release-state composition possessing analytically verifiable characteristics distinct from both naturally occurring source material and conventionally remediated, purified, reconstructed, adulterated, diluted, or artificially reformulated cannabis-derived or hemp-derived materials.

As used herein, the terms “cannabis source” and “hemp source” include cannabis biomass, hemp biomass, cannabis flower, hemp flower, cannabis resin, hemp resin, cannabis extract, hemp extract, cannabis concentrate, hemp concentrate, cannabis oil, hemp oil, trichome-bearing material, dried biomass, cured biomass, fresh biomass, frozen biomass, milled biomass, and combinations thereof. In some embodiments, the cannabis source comprises Cannabis sativa L., Cannabis indica, Cannabis ruderalis, or hybrids thereof. Different cultivars, chemotypes, hybrids, and plant varieties can possess distinct cannabinoid-acid profiles, terpene profiles, volatile profiles, chromatographic signatures, spectroscopic signatures, mass spectrometric patterns, and multivariate analytical fingerprints associated with the original cannabis source.

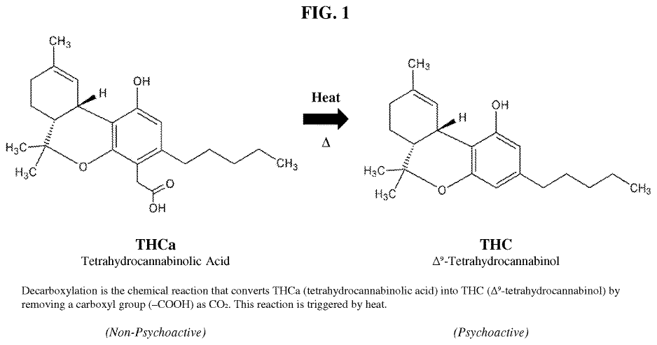

FIG. 1 illustrates a representative decarboxylation reaction in which tetrahydrocannabinolic acid (THCa) undergoes thermal conversion to 49-THC upon exposure to heat. This degradation pathway represents one of the primary mechanisms by which native cannabinoid-acid profiles are destroyed during conventional cannabis or hemp processing. In many embodiments, the disclosed phytofunctional compositions are configured to minimize or substantially eliminate premature decarboxylation, thereby preserving the source-linked cannabinoid-acid relationships present in the original cannabis source or hemp source. FIG. 1 therefore illustrates a representative degradation pathway that the disclosed compositions and methods are designed to avoid, and the presence of significant quantities of neutral THC (rather than acidic THCa) in a processed composition can serve as an exclusion marker indicating unintended or processing-associated decarboxylation.

In some embodiments, the disclosed phytofunctional composition comprises a plurality of native organic acids and one or more native terpenes obtained from a cannabis source or a hemp source, wherein the native organic acids and native terpenes remain analytically associated with the original cannabis source or hemp source despite extraction, drying, formulation, transportation, storage, remediation, or downstream processing. Native organic acids, including cannabinoid acids, can undergo degradation, oxidation, decarboxylation, decomposition, or transformation when exposed to elevated temperatures, oxygen exposure, prolonged storage, irradiation, aggressive remediation, or other destabilizing processing conditions. In some embodiments, the plurality of native organic acids comprises one or more cannabinoid acids selected from tetrahydrocannabinolic acid (THCa), cannabidiolic acid (CBDa), cannabigerolic acid (CBGa), cannabichromenic acid (CBCa), tetrahydrocannabivarinic acid (THCVa), cannabidivarinic acid (CBDVa), cannabinolic acid (CBNa), and combinations thereof. Likewise, native terpenes, including β-myrcene, limonene, α-pinene, β-pinene, linalool, terpinolene, ocimene, humulene, β-caryophyllene, nerolidol, or combinations thereof, can undergo oxidation, volatilization, evaporation, decomposition, or profile stripping during extraction, transportation, remediation, drying, storage, or downstream formulation. Preservation of native cannabinoid-acid relationships and terpene relationships can maintain source-linked aroma signatures, flavor signatures, chromatographic profiles, spectroscopic profiles, volatile profiles, or combinations thereof despite destabilizing processing conditions.

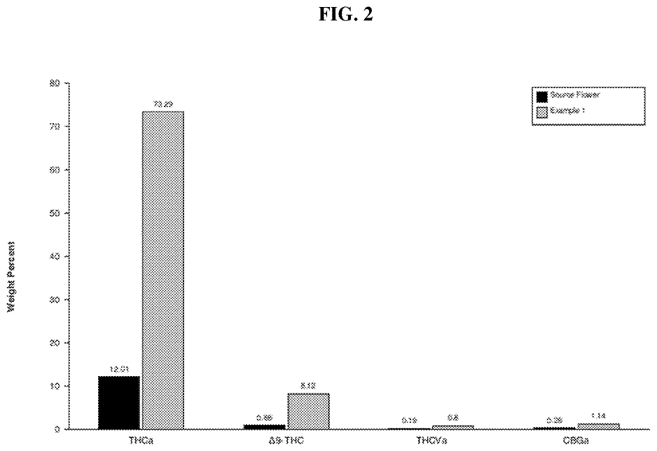

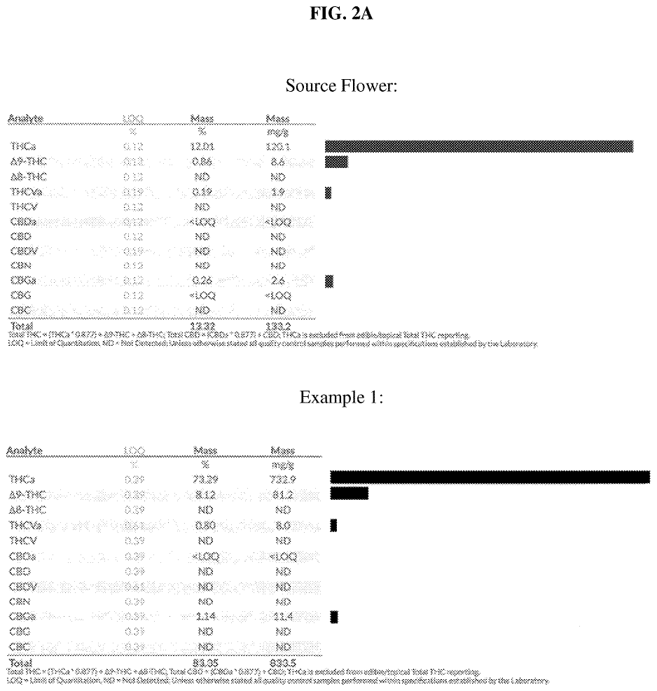

FIG. 2 illustrates a representative comparative cannabinoid profile showing both the source flower cannabinoid-acid distribution and the Example 1 cannabinoid-acid distribution following extraction, concentration, formulation, or downstream processing. In many embodiments, FIG. 2 demonstrates that one or more source-linked cannabinoid-acid relationships remain analytically associated with the original source flower material despite downstream processing capable of chemically altering native cannabinoid-acid relationships and terpene relationships. In many embodiments, tetrahydrocannabinolic acid (THCa) remains the dominant cannabinoid constituent in both the source flower and Example 1 profiles shown in FIG. 2, thereby indicating preservation of source-linked acidic cannabinoid relationships and reduced unintended pre-consumer decarboxylation relative to conventional distillate processing. The visual correspondence between source flower and Example 1 cannabinoid-acid distributions in FIG. 2 therefore illustrates preservation of one or more source-linked analytical relationships within selected analytical tolerances consistent with the disclosed phytofunctional composition claims.

In many embodiments, the disclosed phytofunctional composition is not merely purified cannabis material, purified hemp material, remediated biomass, potency-adjusted plant material, infused biomass, sprayed plant material, re-terpenated extract, or reconstructed cannabinoid formulation. Ordinary purification or remediation can reduce selected contaminants while simultaneously altering native cannabinoid-acid relationships, terpene relationships, volatile profiles, chromatographic signatures, spectroscopic signatures, or other source-linked analytical characteristics associated with the original cannabis source or hemp source. In contrast, the disclosed phytofunctional composition preserves selected source-linked analytical relationships while simultaneously satisfying exclusion-marker criteria associated with degradation, contamination, adulteration, or profile reconstruction.

In many embodiments, the disclosed phytofunctional composition therefore represents a cGMP-compatible pre-consumer release-state composition possessing analytically verifiable characteristics distinct from naturally occurring cannabis-derived or hemp-derived source material, conventionally purified material, destructively remediated material, sprayed biomass, infused biomass, diluted formulations, isolate-spiked formulations, re-terpenated formulations, adulterated formulations, or artificially reconstructed cannabis-derived or hemp-derived compositions. In many embodiments, release-state characterization of the disclosed phytofunctional composition depends upon both: (1) preservation of one or more source-linked analytical characteristics; and (2) substantial absence or reduction of one or more exclusion markers.

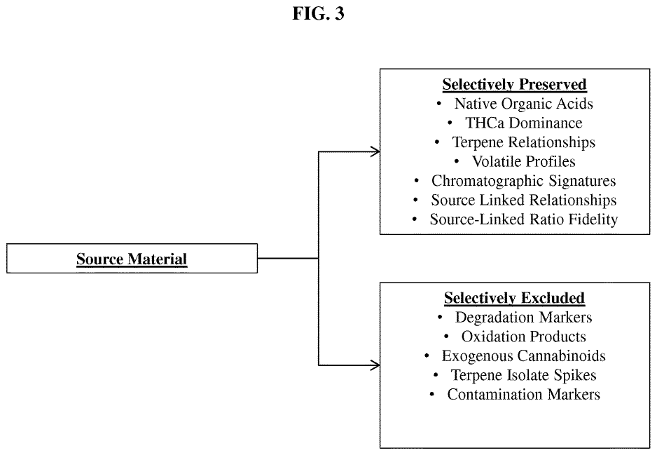

FIG. 3 illustrates a representative selective preservation and selective exclusion analytical framework associated with the disclosed phytofunctional compositions. In many embodiments, the disclosed phytofunctional composition selectively preserves source-linked analytical relationships, including native organic acids, THCa-dominant cannabinoid-acid relationships, terpene relationships, volatile profiles, chromatographic signatures, source-linked ratio fidelity, and source-linked analytical fingerprints associated with the original cannabis source or hemp source. Simultaneously, the disclosed phytofunctional composition selectively excludes or reduces degradation markers, oxidation products, contamination markers, exogenous cannabinoids, terpene isolate spikes, reconstruction markers, adulteration markers, or combinations thereof. Unlike naturally occurring source material, which inherently contains degradation products, microbial contaminants, oxidation products, and other exclusion markers, and unlike conventional distillate, which eliminates native cannabinoid-acid ratios and terpene relationships through processing-associated decarboxylation, the disclosed composition simultaneously retains source-linked chemical identity while excluding naturally co-occurring contaminants and degradation products. FIG. 3 therefore illustrates the core inventive concept of simultaneous selective preservation of unstable native chemistry together with selective exclusion of degradation-associated, contamination-associated, and reconstruction-associated markers to produce a cGMP-compatible analytically verifiable composition state possessing markedly different characteristics from both naturally occurring source material and conventionally processed cannabis or hemp compositions. The ratio-preservation thresholds and exclusion-marker thresholds illustrated in FIG. 3 are representative and non-limiting; specific thresholds, tolerances, analytical values, and subranges are disclosed throughout the specification and claims.

As used herein, the phrase “exclusion marker” refers to a chemical constituent, analytical signature, contamination indicator, degradation product, adulteration indicator, reconstruction indicator, transformation product, residue, impurity, biological contaminant, or other analytically detectable feature associated with contamination, degradation, oxidation, decarboxylation, decomposition, dilution, adulteration, supplementation, profile reconstruction, or other alteration of a cannabis-derived or hemp-derived material relative to the original cannabis source or hemp source. Exclusion markers can include degradation-generated neutral cannabinoids, decarboxylated byproducts, oxidation products, decomposition products, microbial contamination markers, mold markers, mildew markers, fungal markers, spore markers, mycotoxin-associated markers, aflatoxin-associated markers, pesticide residues, heavy metals, residual solvents, exogenous cannabinoids, exogenous terpenes, cannabinoid isolate spikes, terpene isolate spikes, diluents, cutting agents, carrier oils, masking agents, reconstructed profile markers, impurity-pattern anomalies, unexpected chromatographic peaks, unexpected set membership, isotopic anomalies, or combinations thereof. In many embodiments, exclusion markers function as analytical indicators that a cannabis-derived or hemp-derived material has undergone contamination, degradation, remediation, adulteration, supplementation, artificial profile alteration, or other processing conditions capable of altering source-linked chemical identity.

In some embodiments, the disclosed phytofunctional composition is substantially free of degradation-generated neutral cannabinoids, decarboxylated byproducts, oxidation products, decomposition products, microbial contamination, mold, mildew, fungus, spores, mycotoxin-associated markers, aflatoxin-associated markers, pesticides, heavy metals, residual solvents, exogenous cannabinoids, exogenous terpenes, cannabinoid isolate spikes, terpene isolate spikes, diluents, cutting agents, carrier oils, masking agents, reconstructed profile markers, or combinations thereof. As used herein, the phrase “substantially free” can mean absent, substantially absent, not detected, below a selected detection threshold, below a selected quantification threshold, below a selected analytical threshold, below a selected contamination threshold, below a selected cGMP-compatible release threshold, or present in an amount insufficient to materially alter the source-linked analytical identity of the disclosed phytofunctional composition. In some embodiments, one or more exclusion markers are present in amounts less than about 30 percent, 25 percent, 20 percent, 15 percent, 10 percent, 5 percent, 2 percent, 1 percent, 0.5 percent, 0.1 percent, 0.01 percent, 0.001 percent, or lower relative to the total composition, total non-solvent components, or corresponding source-linked analytical profiles. All individual values, thresholds, percentages, concentrations, analytical tolerances, and subranges within the disclosed ranges are expressly contemplated. For example, one or more exclusion markers can be present in amounts from less than about 30 percent to less than about 0.001 percent, including, but not limited to, less than about 25 percent, less than about 20 percent, less than about 15 percent, less than about 10 percent, less than about 5 percent, less than about 2 percent, less than about 1 percent, less than about 0.5 percent, less than about 0.1 percent, less than about 0.01 percent, and all intermediate values and subranges therebetween. In many embodiments, simultaneous preservation of source-linked analytical identity and exclusion of degradation, contamination, adulteration, and reconstruction markers supports cGMP-compatible release-state characterization, contamination control, traceability, anti-reconstitution verification, analytical verification, and regulated cannabis and hemp manufacturing.

In some embodiments, one or more analytical relationships among native chemical constituents present in the cannabis source or hemp source and corresponding analytical relationships present in the phytofunctional composition are preserved within a selected analytical tolerance. As used herein, “native chemical constituents” can include native organic acids, cannabinoid acids, neutral cannabinoids, terpenes, volatile constituents, flavonoids, phenolics, chromatographically detectable constituents, spectroscopically detectable constituents, or combinations thereof naturally associated with the cannabis source or hemp reconstruction, dilution, source before degradation, contamination, remediation, supplementation, or downstream processing. In some embodiments, one or more source-to-output analytical relationships among native chemical constituents differ by less than about 30 percent, 25 percent, 20 percent, 15 percent, 10 percent, 5 percent, 2 percent, 1 percent, 0.5 percent, or 0.1 percent relative to corresponding analytical relationships present in the cannabis source or hemp source. All individual values, analytical thresholds, tolerances, deviations, percentages, ratios, and subranges within the disclosed ranges are expressly contemplated. For example, source-to-output analytical relationships can differ by less than about 30 percent to less than about 0.1 percent, including, but not limited to, less than about 25 percent, less than about 20 percent, less than about 15 percent, less than about 10 percent, less than about 5 percent, less than about 2 percent, less than about 1 percent, less than about 0.5 percent, and all intermediate values and subranges therebetween. In many embodiments, preservation of such analytical relationships can function as an indicator that the disclosed phytofunctional composition remains chemically associated with the original cannabis source or hemp source despite extraction, drying, formulation, transportation, storage, contamination-control processing, remediation, sterilization, or downstream manufacturing conditions capable of chemically altering source-linked profiles.

In some embodiments, one or more ratios between native organic acids present in the cannabis source or hemp source and corresponding ratios present in the phytofunctional composition are preserved within a selected analytical tolerance. As used herein, “native organic acids” can include cannabinoid acids and other acidic constituents naturally associated with the cannabis source or hemp source before degradation, decarboxylation, contamination, remediation, reconstruction, dilution, supplementation, or downstream processing. In some embodiments, one or more source-to-output ratios between native organic acids differ by less than about 50 percent, 45 percent, 40 percent, 35 percent, 30 percent, 25 percent, 20 percent, 15 percent, 10 percent, 5 percent, 2 percent, 1 percent, 0.5 percent, or 0.1 percent relative to corresponding ratios present in the cannabis source or hemp source. All individual values, analytical thresholds, tolerances, deviations, percentages, ratios, and subranges within the disclosed ranges are expressly contemplated. For example, source-to-output native organic-acid ratios can differ by less than about 50 percent to less than about 0.1 percent, including, but not limited to, less than about 25 percent, less than about 20 percent, less than about 15 percent, less than about 10 percent, less than about 5 percent, less than about 2 percent, less than about 1 percent, less than about 0.5 percent, and all intermediate values and subranges therebetween.

In many embodiments, the plurality of native organic acids includes at least a first organic acid (A1) and a second organic acid (A2). A weight ratio of (A1): (A2) present in the phytofunctional composition (RC) can be calculated by dividing the total weight of (A1) present in the phytofunctional composition by the total weight of (A2) present in the phytofunctional composition. A corresponding weight ratio of (A1): (A2) present in the cannabis source or hemp source (RS) can be calculated by dividing the total weight of (A1) present in the cannabis source or hemp source by the total weight of (A2) present in the cannabis source or hemp source. In many embodiments, the percent change between (RS) and (RC) is less than about 20 percent, less than about 10 percent, or less than about 5 percent. Native cannabinoid-acid ratios can be altered through oxidation, heat exposure, decarboxylation, volatilization, prolonged storage, aggressive sterilization, isolate supplementation, dilution, profile reconstruction, or other processing conditions capable of chemically transforming the source-linked profile. Ratio preservation can be determined using ratio drift analysis, chromatographic comparison, spectral comparison, multivariate analysis, principal-component analysis, set-membership preservation, or combinations thereof. Lower percent deviation values can indicate increased preservation of native cannabinoid-acid relationships and reduced degradation during processing. In some embodiments, percent deviation values of less than about 5 percent can indicate minimal oxidation, minimal decarboxylation, minimal thermal degradation, and minimal analytical drift relative to the original cannabis source or hemp source.

In many embodiments, different cannabinoid-acid ratio thresholds can be appropriate for different cannabis species, cultivars, chemotypes, or source-material concentrations. For example, Cannabis sativa L. cultivars can possess different native cannabinoid-acid distributions, relative minor-acid abundances, and terpene-to-cannabinoid relationships compared to Cannabis indica, Cannabis ruderalis, or hybrid cultivars. Likewise, source materials possessing higher initial cannabinoid concentrations (for example, resin-dense flower material possessing total cannabinoid concentrations above about 20 weight percent) can exhibit different concentration-dependent ratio behavior during extraction relative to lower-concentration source materials (for example, trim or leaf material possessing total cannabinoid concentrations below about 10 weight percent). In many embodiments, higher-concentration source materials can exhibit reduced relative ratio drift because the dominant and minor cannabinoid acids are present in proportions closer to their final concentrated state, thereby reducing the magnitude of differential concentration effects during extraction. In other embodiments, lower-concentration source materials can exhibit increased relative ratio drift because extraction and concentration processes amplify small absolute differences between cannabinoid-acid constituents present at very low initial concentrations. Accordingly, in some embodiments, the selected analytical tolerance or percent-change threshold associated with source-to-output ratio preservation can be adjusted based on the species, cultivar, chemotype, or initial cannabinoid concentration of the cannabis source or hemp source. All individual values, analytical thresholds, tolerances, deviations, percentages, ratios, species-dependent adjustments, concentration-dependent adjustments, and subranges are expressly contemplated.

In many embodiments, the disclosed phytofunctional composition can satisfy different source-to-output ratio-preservation thresholds depending on the relative abundance classification of the selected cannabinoid-acid pair and the species, cultivar, chemotype, or initial cannabinoid concentration of the cannabis source or hemp source. When (A1) and (A2) each independently comprise a dominant cannabinoid acid (for example, a cannabinoid acid present at a concentration of at least about 5 weight percent in the cannabis source or hemp source) paired with another dominant cannabinoid acid, source-to-output percent-change values of less than about 45 percent, less than about 40 percent, less than about 30 percent, less than about 20 percent, less than about 10 percent, or less than about 5 percent can be achievable depending on species, cultivar, chemotype, and processing conditions. When (A1) comprises a dominant cannabinoid acid and (A2) comprises a minor cannabinoid acid (for example, a cannabinoid acid present at a concentration of less than about 5 weight percent in the cannabis source or hemp source), source-to-output percent-change values of less than about 45 percent, less than about 40 percent, less than about 35 percent, less than about 30 percent, or less than about 25 percent can be achievable with appropriate selection of processing conditions, extraction parameters, and source-material quality. When (A1) and (A2) each independently comprise a minor cannabinoid acid present at a concentration of less than about 5 weight percent, less than about 3 weight percent, less than about 2 weight percent, less than about 1 weight percent, or less than about 0.5 weight percent in the cannabis source or hemp source, source-to-output percent-change values of less than about 20 percent, less than about 15 percent, less than about 10 percent, less than about 5 percent, less than about 2 percent, or less than about 1 percent can be achievable because minor cannabinoid-acid pairs can exhibit similar physicochemical properties, co-extraction behavior, and concentration-dependent drift characteristics. All individual values, analytical thresholds, tolerances, deviations, percentages, ratios, weight-percent concentration thresholds, species-dependent adjustments, concentration-dependent adjustments, abundance-classification-dependent adjustments, and subranges are expressly contemplated. In some embodiments, Cannabis sativa L. cultivars possessing higher initial total cannabinoid concentrations (for example, above about 15, 20, or 25 weight percent) can satisfy tighter ratio-preservation thresholds relative to lower-concentration Cannabis indica, Cannabis ruderalis, or hybrid source materials, and such species-dependent or concentration-dependent threshold adjustments are expressly contemplated within the scope of the disclosed claims.

As used herein, the term “minor cannabinoid acid” refers to a cannabinoid acid present at a concentration of less than about 10 weight percent, less than about 5 weight percent, less than about 3 weight percent, less than about 2 weight percent, less than about 1 weight percent, or less than about 0.5 weight percent in the cannabis source or hemp source, based on total weight of the cannabis source or hemp source. In contrast, a “dominant cannabinoid acid” or “major cannabinoid acid” refers to a cannabinoid acid present at a concentration of at least about 5 weight percent, at least about 10 weight percent, at least about 15 weight percent, or at least about 20 weight percent in the cannabis source or hemp source, based on total weight of the cannabis source or hemp source. By way of non-limiting example, tetrahydrocannabinolic acid (THCa) present at approximately 12.01 weight percent in the source flower of Example 1 functions as a representative dominant cannabinoid acid, while tetrahydrocannabivarinic acid (THCVa) present at approximately 0.19 weight percent and cannabigerolic acid (CBGa) present at approximately 0.26 weight percent in the source flower of Example 1 each independently function as representative minor cannabinoid acids within the meaning of this disclosure. In some embodiments, the classification of a cannabinoid acid as a minor cannabinoid acid or a dominant cannabinoid acid can depend on the species, cultivar, chemotype, or harvest conditions of the cannabis source or hemp source, such that a cannabinoid acid classified as a minor cannabinoid acid in one cultivar or chemotype can be classified as a dominant cannabinoid acid in a different cultivar or chemotype. All individual values, weight-percent concentration thresholds, classification boundaries, and subranges within the foregoing ranges are expressly contemplated and disclosed, including but not limited to less than about 8 weight percent, less than about 6 weight percent, less than about 4 weight percent, less than about 1.5 weight percent, less than about 0.75 weight percent, and less than about 0.25 weight percent, and all values, subranges, and combinations thereof.

In some embodiments, the disclosed phytofunctional composition preserves one or more source-linked analytical profiles associated with the cannabis source or hemp source. Such source-linked analytical profiles can include cannabinoid-acid ratios, acid-to-neutral cannabinoid ratios, terpene ratios, volatile constituent profiles, chromatographic peak patterns, spectroscopic patterns, mass spectrometric patterns, multivariate analytical profiles, or combinations thereof. In some embodiments, one or more preserved source-linked analytical profiles differ from corresponding source-linked analytical profiles present in the cannabis source or hemp source by less than about 50 percent, 40 percent, 30 percent, 15 percent, 10 percent, 5 percent, 2 percent, 1 percent, 0.5 percent, or 0.1 percent. All individual values, analytical thresholds, tolerances, deviations, percentages, ratios, and subranges within the disclosed ranges are expressly contemplated. For example, selected analytical relationships can differ by less than about 50 percent to less than about 0.1 percent, including, but not limited to, less than about 25 percent, less than about 20 percent, less than about 15 percent, less than about 10 percent, less than about 5 percent, less than about 2 percent, less than about 1 percent, less than about 0.5 percent, and all intermediate values and subranges therebetween. In many embodiments, cannabinoid-acid ratios and acid-to-neutral cannabinoid ratios can indicate the degree of decarboxylation, oxidation, degradation, or thermal exposure associated with the phytofunctional composition, while terpene ratios and volatile constituent profiles can indicate the degree of volatilization, oxidation, evaporation, or profile stripping associated with processing conditions. Chromatographic peak patterns, spectroscopic patterns, mass spectrometric patterns, and multivariate analytical profiles can function as source-linked analytical fingerprints capable of distinguishing the disclosed phytofunctional composition from reconstructed, diluted, contaminated, adulterated, remediated, or artificially reformulated cannabis and hemp materials. Analytical preservation can be determined using chromatographic correlation, spectral similarity, multivariate similarity, principal-component similarity, ratio drift analysis, set-membership preservation, or combinations thereof. In many embodiments, analytical tolerances of less than about 20 percent can indicate preservation of source-linked chemical identity, while tolerances of less than about 10 percent or less than about 5 percent can indicate reduced degradation, reduced oxidation, reduced decarboxylation, reduced analytical drift, and increased preservation of native source-linked relationships associated with the cannabis source or hemp source.

In some embodiments, the disclosed phytofunctional composition exhibits a multivariate similarity score of at least about 0.80, at least about 0.85, at least about 0.90, at least about 0.95, or greater relative to the cannabis source or hemp source. As used herein, a “multivariate similarity score” refers to a statistical or analytical comparison between multiple analytical variables associated with the cannabis source or hemp source and corresponding variables associated with the phytofunctional composition. Such variables can include cannabinoid concentrations, cannabinoid-acid ratios, acid-to-neutral cannabinoid relationships, terpene concentrations, terpene ratios, volatile constituent profiles, chromatographic peak patterns, spectroscopic patterns, mass spectrometric distributions, impurity patterns, or combinations thereof. All individual values, analytical thresholds, similarity values, and subranges within the disclosed multivariate similarity ranges are expressly contemplated, including, but not limited to, similarity scores of at least about 0.80, 0.82, 0.85, 0.88, 0.90, 0.92, 0.95, 0.98, and all intermediate values and subranges therebetween. In many embodiments, multivariate similarity can be determined using principal-component analysis, clustering analysis, multidimensional statistical comparison, spectral comparison, chromatographic comparison, machine-learning analysis, set-membership analysis, or combinations thereof.

In some embodiments, a multivariate similarity score of at least about 0.80 can indicate substantial preservation of source-linked analytical identity despite extraction, drying, formulation, transportation, storage, remediation, sterilization, or downstream processing conditions capable of altering native chemical relationships. In other embodiments, multivariate similarity scores of at least about 0.90 can indicate reduced degradation, oxidation, decarboxylation, volatilization, contamination, and analytical drift relative to the cannabis source or hemp source. In many embodiments, higher multivariate similarity scores can indicate increased preservation of source-linked cannabinoid-acid profiles, terpene relationships, volatile constituent profiles, chromatographic signatures, spectroscopic signatures, or combinations thereof and can distinguish the disclosed phytofunctional composition from reconstructed, diluted, remediated, adulterated, or artificially reformulated cannabis and hemp materials. In some embodiments, the selected analytical tolerance comprises less than about 10 percent deviation. In other embodiments, the selected analytical tolerance comprises less than about 5 percent deviation. Lower analytical tolerances can indicate increased preservation of source-linked cannabinoid-acid relationships, terpene relationships, and volatile constituent relationships originally present in the cannabis source or hemp source.

As set forth above, the plurality of native organic acids can comprise one or more cannabinoid acids selected from tetrahydrocannabinolic acid (THCa), cannabidiolic acid (CBDa), cannabigerolic acid (CBGa), cannabichromenic acid (CBCa), tetrahydrocannabivarinic acid (THCVa), cannabidivarinic acid (CBDVa), cannabinolic acid (CBNa), and combinations thereof. Such cannabinoid acids can function as native source-linked constituents associated with the original cannabis source or hemp source. In many embodiments, preservation of cannabinoid-acid profiles can reduce degradation-associated transformation into corresponding neutral cannabinoids.

In some embodiments, one or more neutral cannabinoids formed from unintended pre-consumer decarboxylation of the plurality of native organic acids are absent or present below a selected threshold. As used herein, the phrase “selected threshold” refers to a predetermined concentration limit, detection limit, quantification limit, regulatory limit, safety limit, batch-release limit, or analytical acceptance criterion chosen by the practitioner, manufacturer, or regulatory authority based on the intended use, product category, regulatory requirements, analytical method sensitivity, or cGMP-compatible release specifications associated with the phytofunctional composition. In some embodiments, the selected threshold comprises less than about 30 percent, 25 percent, 20 percent, 15 percent, 10 percent, 5 percent, 2 percent, 1 percent, 0.5 percent, 0.1 percent, 0.05 percent, 0.01 percent, or 0.001 percent relative to the native cannabinoid-acid profile originally present in the cannabis source or hemp source, or a non-detected level as determined by a validated analytical method. All individual values, thresholds, percentages, concentrations, detection limits, and subranges within the foregoing ranges are expressly contemplated. As used herein, the phrase “unintended pre-consumer decarboxylation” refers to conversion of one or more native cannabinoid acids into corresponding neutral cannabinoids prior to intentional consumer heating, combustion, vaporization, ingestion, or other end-user transformation. In many embodiments, tetrahydrocannabinolic acid (THCa) is constituent while degradation-generated maintained as a native source-linked tetrahydrocannabinol (THC) formed through premature heat exposure, oxidation, storage instability, remediation, or processing is absent or maintained below a selected threshold. In many such embodiments, preservation of the original cannabinoid-acid profile maintains source-linked chemical identity, preserves native cannabinoid-acid relationships, reduces degradation-associated profile drift, and distinguishes the disclosed phytofunctional composition from decarboxylated, reconstructed, degraded, remediated, or artificially reformulated cannabis and hemp compositions.

In some embodiments, the plurality of native organic acids undergoes decarboxylation upon exposure to temperatures from about 90° C. to about 150° C. Decarboxylation refers to removal of a carboxyl group from a cannabinoid acid, resulting in formation of a corresponding neutral cannabinoid. Such conversion can occur during extraction, drying, transportation, remediation, sterilization, packaging, storage, or downstream processing. In many embodiments, preservation of native cannabinoid-acid profiles below such temperatures can reduce unintended formation of degradation-generated neutral cannabinoids and preserve source-linked analytical identity associated with the cannabis source or hemp source. Monitoring temperature exposure can therefore function as both a manufacturing-control mechanism and a cGMP-compatible quality-control mechanism.

In some embodiments, the plurality of native organic acids is present in an amount from about 55 weight percent to about 95 weight percent, based on non-solvent components of the phytofunctional composition. Such concentration ranges can indicate preservation of native acidic cannabinoid profiles originally present in the cannabis source or hemp source. In many embodiments, higher concentrations of native organic acids correlate with reduced degradation, reduced oxidation, reduced decarboxylation, and reduced profile stripping associated with conventional remediation or purification processes. Such ranges can also support analytical verification and release-state characterization.

In some embodiments, the disclosed phytofunctional composition is substantially free of one or more decarboxylated byproducts formed from the plurality of native organic acids prior to consumer use. In many such embodiments, the phytofunctional composition is substantially free of mold, bacterial contamination, pesticide residues, and heavy metals. As used herein, the phrase “substantially free” can mean absent, not detected, below a detection threshold, below a quantification threshold, below a regulatory threshold, below a selected safety threshold, or below a selected cGMP-compatible release threshold. Exclusion of such contaminants can preserve product stability, improve release-state characterization, support contamination control, and distinguish the disclosed embodiments from degraded, contaminated, or adulterated cannabis and hemp materials.

In some embodiments, the one or more native terpenes comprise one or more terpenes selected from β-myrcene, limonene, α-pinene, β-pinene, linalool, terpinolene, ocimene, humulene, β-caryophyllene, nerolidol, and combinations thereof. Such terpenes can function as source-linked volatile constituents associated with the original cannabis source or hemp source. Different cultivars and chemotypes can possess distinct terpene distributions and terpene-ratio relationships. Preservation of native terpene profiles can therefore maintain source-linked aroma signatures, flavor signatures, analytical fingerprints, and cultivar-linked characteristics associated with the cannabis source or hemp source.

In some embodiments, the one or more native terpenes possess boiling points between about 100° C. and about 200° C. Such boiling-point ranges can make the native terpenes susceptible to volatilization, degradation, oxidation, or profile stripping during extraction, remediation, transportation, or processing. In many embodiments, preservation of such terpenes can indicate reduced thermal damage relative to conventional processing techniques. Maintenance of volatile terpene constituents can also improve analytical similarity between the resulting phytofunctional composition and the original cannabis source or hemp source.

In some embodiments, the one or more native terpenes are present in an amount from about 3 weight percent to about 25 weight percent, based on non-solvent components of the phytofunctional composition. Preservation of such terpene concentrations can maintain source-linked volatile profiles and reduce profile drift associated with oxidation, evaporation, remediation, or reconstruction. In many embodiments, terpene concentration ranges can also function as analytical release-state criteria.

In some embodiments, terpene profiles, volatile profiles, terpene set membership, or terpene-ratio relationships may be used as secondary source-linked analytical characteristics, sensory identity characteristics, aroma or flavor characteristics, formulation markers, or anti-reconstruction indicators. In other embodiments, the primary source-linked analytical characteristics comprise cannabinoid-acid profiles, raw cannabinoid profiles, acid-to-neutral cannabinoid relationships, cannabinoid-acid ratios, THC-threshold criteria, degradation-marker criteria, chromatographic cannabinoid profiles, spectroscopic profiles, mass-spectrometric profiles, or multivariate cannabinoid-dominant analytical fingerprints. Because terpene constituents can be volatile and may change during otherwise acceptable processing, storage, formulation, transportation, or handling, preservation of terpene ratios or volatile profiles need not be required in every embodiment unless expressly selected as a release criterion. In many embodiments, recorded, cGMP-compatible terpene additions or adjustments do not defeat the claimed composition state provided such additions or adjustments are documented and do not materially alter selected cannabinoid-acid fingerprint criteria, THC-threshold criteria, designated-adulterant exclusion criteria, residual-solvent criteria, or source-authentication criteria. In contrast, undisclosed terpene spiking, unrecorded re-terpenation, reconstructed aroma signatures, or terpene-profile engineering inconsistent with batch records may function as exclusion markers, adulteration markers, or reconstruction markers within the meaning of this disclosure.

The disclosed phytofunctional composition can optionally further comprise a solvent. In some embodiments, the solvent is selected from the group consisting of heptane, n-heptane, hexane, n-hexane, pentane, isopentane, cyclohexane, methylcyclohexane, ethanol, isopropanol, butanol, ethyl acetate, methyl acetate, acetone, methyl ethyl ketone, diethyl ether, methyl tert-butyl ether, petroleum ether, and combinations thereof. In some embodiments, the solvent is a non-polar solvent. In some embodiments, the solvent is a hydrocarbon solvent. In some embodiments, the solvent comprises an aliphatic hydrocarbon selected from the group consisting of heptane, n-heptane, hexane, n-hexane, pentane, isopentane, cyclohexane, methylcyclohexane, and combinations thereof. In other embodiments, the solvent comprises a polar or partially polar solvent selected from the group consisting of ethanol, isopropanol, butanol, ethyl acetate, methyl acetate, acetone, methyl ethyl ketone, and combinations thereof. In many embodiments, the solvent is compatible with cGMP-oriented manufacturing processes and does not materially alter one or more source-linked cannabinoid-acid relationships, terpene relationships, or analytical fingerprints associated with the cannabis source or hemp source.

In some embodiments, the solvent is present in an amount from about 0.01 parts by weight to about 95 parts by weight, based on 100 parts by weight of the phytofunctional composition. In other embodiments, the solvent is present in an amount from about 0.1 parts by weight to about 80 parts by weight, from about 0.5 parts by weight to about 60 parts by weight, from about 1 part by weight to about 50 parts by weight, from about 2 parts by weight to about 30 parts by weight, or from about 5 parts by weight to about 20 parts by weight, based on 100 parts by weight of the phytofunctional composition. In some embodiments, the solvent is present in an amount less than about 95, 90, 85, 80, 75, 70, 65, 60, 55, 50, 45, 40, 35, 30, 25, 20, 15, 10, 5, 2, 1, 0.5, 0.1, or 0.01 parts by weight, based on 100 parts by weight of the phytofunctional composition. All individual values, concentrations, weight ratios, and subranges within the disclosed ranges are expressly contemplated. For example, solvent concentrations can range from about 0.01 parts by weight to about 95 parts by weight, including, but not limited to, about 0.05, 0.1, 0.5, 1, 2, 3, 5, 8, 10, 12, 15, 20, 25, 30, 35, 40, 45, 50, 55, 60, 65, 70, 75, 80, 85, 90, and 95 parts by weight, based on 100 parts by weight of the phytofunctional composition, and all intermediate values and subranges therebetween. In many embodiments, lower residual solvent concentrations can indicate more complete solvent removal and can support cGMP-compatible release-state characterization, contamination control, and downstream formulation compatibility.

In some embodiments, the solvent comprises heptane. Heptane is a non-polar aliphatic hydrocarbon solvent possessing a boiling point of approximately 98° C., which is near the lower end of the decarboxylation temperature range of native cannabinoid acids and permits solvent removal through brief evaporative exposure before significant decarboxylation can occur. In many embodiments, use of heptane as the solvent can facilitate extraction, concentration, or formulation of the disclosed phytofunctional composition while reducing the risk of thermally induced decarboxylation, oxidation, or degradation of native cannabinoid-acid profiles and terpene profiles associated with the cannabis source or hemp source. In some embodiments, heptane can be removed from the phytofunctional composition through evaporation, rotary evaporation, vacuum distillation, or other solvent-removal techniques at reduced pressures and temperatures at or below about 98° C., thereby minimizing thermal exposure and preserving source-linked cannabinoid-acid relationships and volatile terpene relationships. In many embodiments, residual heptane levels in the disclosed phytofunctional composition are maintained below selected cGMP-compatible analytical thresholds. In some embodiments, heptane is selected as the solvent because of its low toxicity relative to other hydrocarbon solvents, its compatibility with cGMP-oriented cannabis and hemp manufacturing processes, and its ability to dissolve cannabinoid acids and terpenes without materially altering source-linked analytical fingerprints.

In some embodiments, the disclosed phytofunctional composition can exist in two distinct composition states possessing different storage-stability characteristics depending on the degree of residual solvent removal following ATC-enabled processing or other extraction and purification processes. A first composition state comprises an intermediate post-extraction solvent-containing composition formed after substantial solvent reduction from the crude extraction output, wherein the intermediate composition retains a residual processing solvent fraction of about 15 to about 25 percent by volume relative to the original crude extraction solvent volume. In many embodiments, such intermediate solvent-containing compositions can exhibit practical storage stability at room temperature or controlled moderate-temperature conditions, including temperatures from about 20° C. to about 24° C. (about 68° F. to about 75° F.), and potentially up to about 38° C. (about 100° F.), wherein the plurality of native organic acids and the one or more native terpenes do not substantially degrade, decarboxylate, decompose, oxidize, volatilize, or transform. In many embodiments, the residual processing solvent present in the intermediate composition contributes to stabilization of the chemically sensitive native cannabinoid-acid profile by maintaining the native organic acids and native terpenes in a solvated or partially solvated state that reduces oxidative exposure, limits molecular mobility associated with degradation pathways, and slows decarboxylation kinetics relative to the dried or near-zero-solvent finished composition. Such intermediate storage stability at ordinary room temperatures or controlled moderate temperatures can reduce unintended profile drift and preserve source-linked chemical identity during manufacturing, transportation, warehousing, or commercial holding prior to final solvent removal, formulation, or batch release.

In many embodiments, the intermediate post-extraction solvent-containing composition represents an about 80 percent solvent reduction from the crude extraction source material, leaving about 20 percent of the original processing solvent volume. In many embodiments, the residual processing solvent comprises heptane or another non-polar aliphatic hydrocarbon solvent. The intermediate solvent-containing composition can function as a commercially valuable stabilized storage format, a transferable intermediate material, a warehousing-compatible form, or a holding-state composition suitable for controlled-temperature storage, transportation, or commercial distribution prior to final solvent removal and cGMP-compatible batch release. In many embodiments, chilled or temperature-controlled storage of the intermediate solvent-containing composition is preferred but not required for short-term or moderate-duration storage at ordinary room temperatures. In many embodiments, the intermediate solvent-containing composition is materially different from the finished dried or near-zero-solvent composition in both residual solvent content and storage-stability behavior.

A second composition state comprises the finished cGMP-compatible release-state composition formed after substantially complete removal of the processing solvent to meet finished-product release specifications. In many embodiments, the finished dried or near-zero-solvent composition does not exhibit the same room-temperature storage stability as the intermediate solvent-containing composition and should be stored under reduced-temperature conditions, including cool or cold storage, refrigeration, or other temperature-controlled conditions sufficient to slow degradation of native cannabinoid acids, reduce continued decarboxylation, reduce oxidation, reduce decomposition, and prevent self-adulteration of the cannabinoid-acid profile over time. In many embodiments, the finished composition behaves as a refrigerated or cold-storage product whose native cannabinoid-acid profile can degrade, decarboxylate, oxidize, or otherwise transform if maintained at ordinary room temperatures for extended periods without temperature control.

In many embodiments, the finished phytofunctional composition is a storage-condition-sensitive release-state product whose continued conformity with one or more claimed release-state criteria depends on maintaining reduced-temperature storage, cool or cold storage, refrigerated storage, or other controlled-temperature conditions sufficient to preserve selected cannabinoid-acid profile criteria, THC-threshold criteria, designated-adulterant exclusion criteria, residual-solvent criteria, and source-authentication criteria. Unlike the intermediate solvent-containing composition, which can exhibit practical stability at room temperature or controlled moderate temperatures due to the stabilizing effect of residual processing solvent, the finished dried or near-zero-solvent composition is susceptible to continued decarboxylation, oxidation, decomposition, and self-adulteration at ordinary room temperatures. In many embodiments, continued conformity of the finished phytofunctional composition with one or more release-state specifications may be verified by analytical testing of the finished product at any point during storage, distribution, or commercial shelf life. In some embodiments, failure to maintain reduced-temperature storage conditions can result in degradation, oxidation, decarboxylation, or profile drift such that the finished composition no longer satisfies one or more release-state criteria, exclusion-marker criteria, THC-threshold criteria, or source-linked analytical-tolerance criteria.

In some embodiments, the disclosed phytofunctional composition possesses a pH from about 6.0 to about 7.2. Maintaining the disclosed pH range can improve stability of sensitive cannabinoid acids, reduce oxidation, reduce degradation, improve storage stability, and support compatibility with downstream dosage forms and formulations. In many embodiments, pH adjustment can reduce microbial growth and improve cGMP-compatible contamination control.

In some embodiments, the disclosed phytofunctional composition is configured as a cGMP-compatible consumption-safe composition suitable for downstream incorporation into consumer products, compounding formulations, formulation-ready intermediates, manufacturing inputs, or incorporation-ready compositions. The composition can comprise a plurality of native organic acids obtained from a cannabis source or a hemp source together with one or more native terpenes obtained from the cannabis source or hemp source and a consumption-safe carrier, medium, matrix, solvent, excipient, formulation base, or combinations thereof. Suitable consumption-safe carriers or formulation components can include edible oils, plant-derived oils, triglycerides, phospholipid systems, emulsifiers, encapsulation matrices, aqueous carriers, alcohols, glycols, suspending agents, powders, gums, polysaccharides, biodegradable polymers, ingestible excipients, pharmaceutical excipients, nutraceutical excipients, food-grade excipients, or combinations thereof. In many embodiments, one or more source-linked analytical relationships associated with the cannabis source or hemp source remain preserved within a selected analytical tolerance despite incorporation into the consumption-safe composition. Simultaneously, the disclosed composition can remain substantially free of degradation-generated neutral cannabinoids, contamination markers, adulteration markers, reconstruction markers, or combinations thereof associated with naturally occurring source material, downstream processing, or artificial profile reconstruction.

In many embodiments, the disclosed consumption-safe composition is configured as a formulation-ready composition, compounding composition, cGMP-compatible intermediate composition, downstream manufacturing composition, or incorporation-ready composition suitable for use in regulated cannabis-derived or hemp-derived manufacturing workflows. The disclosed composition can therefore function as a commercially transferable intermediate material configured for incorporation into capsules, tablets, beverages, powders, suspensions, solutions, emulsions, ingestible products, inhalable products, topical products, oral products, or combinations thereof while maintaining one or more source-linked analytical relationships associated with the original cannabis source or hemp source. In many embodiments, incorporation of the disclosed composition into downstream products does not materially alter one or more preserved cannabinoid-acid relationships, terpene relationships, volatile profiles, chromatographic signatures, spectroscopic signatures, multivariate analytical relationships, or combinations thereof. Such embodiments can support cGMP-compatible formulation workflows, downstream manufacturing consistency, release-state characterization, traceability, contamination control, and analytical verification.

In some embodiments, the disclosed consumption-safe composition preserves one or more native acidic cannabinoid profiles while remaining substantially free of degradation-generated neutral cannabinoids above a selected threshold. As used herein, “degradation-generated neutral cannabinoids” can include THC, CBD, CBG, CBC, THCV, CBDV, CBN, or other neutral cannabinoids formed through unintended pre-consumer decarboxylation, oxidation, degradation, decomposition, storage instability, thermal exposure, or downstream processing of corresponding native cannabinoid acids. In many embodiments, preservation of native acidic cannabinoid profiles within the disclosed consumption-safe composition can reduce analytical drift associated with degradation while maintaining source-linked cannabinoid-acid relationships associated with the original cannabis source or hemp source. In some embodiments, the disclosed consumption-safe composition is analytically distinguishable from naturally occurring cannabis biomass, hemp biomass, ordinary extract material, diluted formulations, isolate-spiked formulations, re-terpenated formulations, or reconstructed cannabinoid formulations because the disclosed composition simultaneously preserves selected source-linked analytical relationships while reducing, eliminating, or controlling degradation markers, contamination markers, adulteration markers, or reconstruction markers not naturally absent from untreated source material.

In preferred embodiments, the disclosed consumption-safe composition excludes tobacco, tobacco-derived material, nicotine-containing material, and tobacco-product components. Such exclusion can distinguish the disclosed embodiments from tobacco products, nicotine-delivery products, combustible tobacco materials, tobacco-derived inhalation systems, or nicotine-containing formulations. In many embodiments, the disclosed consumption-safe composition represents a non-tobacco cGMP-compatible analytical composition state possessing source-linked cannabis-derived or hemp-derived analytical characteristics together with selected exclusion-marker characteristics not naturally present simultaneously in untreated cannabis biomass, untreated hemp biomass, ordinary purified material, or conventionally reconstructed cannabis-derived or hemp-derived formulations.

In many embodiments, the disclosed phytofunctional composition satisfies one or more cGMP-compatible batch-release specifications. Such specifications can include preservation of one or more source-linked cannabinoid-acid profiles and exclusion of one or more contaminants. In many embodiments, release-state verification is based on both fingerprint preservation and exclusion-marker criteria. Such release specifications can support regulated manufacturing, analytical verification, contamination control, and traceability.

In some embodiments, the disclosed phytofunctional composition is substantially free of exogenous terpenes not originally present in the cannabis source or hemp source. As used herein, the phrase “exogenous terpene” refers to a terpene added through supplementation, profile reconstruction, isolate spiking, flavor enhancement, or artificial rebuilding rather than originating from the cannabis source or hemp source itself. Exclusion of exogenous terpenes can preserve source-linked analytical identity and reduce artificial modification of aroma signatures and flavor signatures.

In some embodiments, the disclosed phytofunctional composition is substantially free of exogenous cannabinoids not originally present in the cannabis source or hemp source. Exogenous cannabinoids can include added isolates, supplemented cannabinoids, or artificially introduced cannabinoid constituents inconsistent with the original source-linked profile. In many embodiments, exclusion of such constituents can reduce profile engineering and preserve source-linked cannabinoid-acid relationships.

In some embodiments, the disclosed phytofunctional composition is substantially free of terpene isolate spikes inconsistent with the cannabis source or hemp source. In many embodiments, isolate spikes can indicate profile reconstruction, re-terpenation, or artificial enhancement of aroma or flavor characteristics. Analytical detection of isolate spikes can include chromatographic analysis, ratio analysis, multivariate analysis, or combinations thereof.

In some embodiments, the disclosed phytofunctional composition is substantially free of cannabinoid isolate spikes inconsistent with the cannabis source or hemp source. In many embodiments, cannabinoid isolate spikes can indicate dilution, supplementation, potency manipulation, or artificial profile engineering. Exclusion of isolate spikes can preserve source-linked analytical identity and maintain consistency between the phytofunctional composition and the original cannabis source or hemp source.

In some embodiments, the disclosed phytofunctional composition is substantially free of reconstructed aroma signatures or reconstructed flavor signatures inconsistent with the cannabis source or hemp source. Such reconstructed profiles can result from addition of exogenous terpenes, flavorants, masking agents, carrier oils, or artificial profile reconstruction techniques. In many embodiments, reconstructed profiles can indicate loss of native source-linked relationships among cannabinoid acids, terpenes, volatile constituents, or combinations thereof.

The disclosed phytofunctional composition can comprise cannabis resin, hemp resin, cannabis extract, hemp extract, cannabis concentrate, hemp concentrate, oil, slurry, powder, particulate material, dried biomass, semi-solid material, or combinations thereof. Such forms can be configured for downstream packaging, extraction, formulation, concentration, or incorporation into dosage forms. Different physical forms can exhibit different stability characteristics, terpene-retention characteristics, or cannabinoid-acid preservation characteristics.

A method of characterizing or releasing a cGMP-compatible phytofunctional composition formed from a cannabis source or a hemp source is also disclosed. The method comprises obtaining source-fingerprint data from an identifiable cannabis source or hemp source and obtaining output-fingerprint data from a resulting phytofunctional composition. Source-fingerprint data can include chromatographic data, spectroscopic data, cannabinoid-acid ratios, terpene profiles, volatile profiles, mass spectrometric profiles, multivariate analytical data, or combinations thereof. Such analytical information can establish a baseline source-linked fingerprint associated with the cannabis source or hemp source.

In some embodiments, the method further comprises comparing the source-fingerprint data and the output-fingerprint data to determine preservation of one or more source-linked cannabinoid profiles, cannabinoid-acid profiles, terpene profiles, volatile profiles, chromatographic profiles, spectroscopic profiles, or combinations thereof. Such comparisons can determine whether the resulting phytofunctional composition remains analytically associated with the original cannabis source or hemp source. In many embodiments, analytical similarity functions as a release-state verification criterion.

In many embodiments, the method further comprises testing the resulting phytofunctional composition for one or more degradation markers, decarboxylation markers, microbial contaminants, fungal contaminants, pesticide residues, heavy metals, residual solvents, exogenous terpenes, exogenous cannabinoids, isolate spikes, or reconstructed profile markers. Such testing can support contamination control, anti-reconstitution verification, analytical characterization, and cGMP-compatible release-state determination. In many embodiments, failure of one or more exclusion criteria can indicate contamination, degradation, adulteration, or profile reconstruction.

In some embodiments, the resulting phytofunctional composition is designated as a cGMP-compatible release-state phytofunctional composition only when one or more source-linked profiles are preserved within a selected analytical tolerance and one or more contaminants, degradation markers, adulteration markers, or reconstruction markers satisfy one or more exclusion criteria. In many embodiments, failure of either criterion can result in rejection, segregation, downgrading, additional testing, or exclusion from the claimed composition category. Such dual-condition release criteria can distinguish the disclosed embodiments from ordinary remediation or purification processes.

In some embodiments, the source-fingerprint data comprise chromatographic data. Chromatographic data can include retention-time profiles, peak-area distributions, cannabinoid profiles, terpene profiles, impurity patterns, or combinations thereof. Chromatographic analysis can function as a source-linkage mechanism supporting analytical identity preservation.

In some embodiments, the source-fingerprint data comprise spectroscopic data. Spectroscopic data can include infrared spectra, ultraviolet-visible spectra, absorbance patterns, emission patterns, or combinations thereof. Spectroscopic comparison can identify degradation-associated changes, oxidation-associated changes, or reconstruction-associated changes.

In some embodiments, the source-fingerprint data comprise mass spectrometric data. Mass spectrometric data can include ion distributions, fragmentation patterns, isotopic patterns, or combinations thereof. Mass spectrometric analysis can support detection of exogenous constituents, degradation products, or contamination markers.

In some embodiments, the source-fingerprint data comprise multivariate analytical data. Multivariate analytical data can include principal-component relationships, clustering relationships, statistical similarity measurements, or combinations thereof. Such analytical approaches can compare multiple variables simultaneously in order to preserve source-linked analytical identity.

In some embodiments, the comparing step comprises determining ratio drift between source-linked cannabinoid-acid ratios and output cannabinoid-acid ratios. Ratio drift can indicate degradation, oxidation, decarboxylation, contamination, dilution, supplementation, or artificial profile alteration. Lower ratio drift values can indicate greater preservation of native source-linked cannabinoid-acid relationships.

In some embodiments, the comparing step comprises determining chromatographic correlation. In many embodiments, chromatographic correlation can compare source-linked retention-time distributions and peak-area relationships associated with the cannabis source or hemp source and the resulting phytofunctional composition. Higher chromatographic correlation can indicate greater preservation of source-linked analytical identity.

In some embodiments, the comparing step comprises determining spectral similarity. Spectral similarity can include comparison of spectroscopic absorbance patterns, emission patterns, or combinations thereof. In many embodiments, lower spectral similarity can indicate degradation, oxidation, contamination, or artificial profile reconstruction.

In some embodiments, the comparing step comprises determining principal-component similarity. Principal-component similarity can determine whether the resulting phytofunctional composition remains clustered with the original cannabis source or hemp source within a multivariate analytical space. Such clustering analysis can support release-state verification.

In some embodiments, the comparing step comprises determining set-membership preservation. Set-membership preservation can determine whether unexpected terpenes, cannabinoids, isolate spikes, flavorants, diluents, or reconstruction markers are present in the resulting phytofunctional composition. In many embodiments, unexpected set membership can indicate adulteration or artificial reconstruction.

In some embodiments, the resulting phytofunctional composition is substantially free of degradation-generated THC. As used herein, “degradation-generated THC” refers to THC formed through unintended pre-consumer decarboxylation of native tetrahydrocannabinolic acid (THCa) during extraction, drying, transportation, storage, remediation, sterilization, formulation, or other processing conditions. In many embodiments, degradation-generated THC functions as a decarboxylation marker associated with premature conversion of native THCa into THC prior to intentional consumer heating or end-user transformation. In some embodiments, degradation-generated THC is absent or present below a selected analytical threshold, including thresholds of less than about 20 percent, 15 percent, 10 percent, 5 percent, 2 percent, 1 percent, 0.5 percent, or 0.1 percent relative to the original source-linked THCa profile. Reduction or elimination of degradation-generated THC can preserve native cannabinoid-acid relationships, reduce profile drift associated with heat exposure or oxidation, and maintain source-linked chemical identity associated with the cannabis source or hemp source.

In some embodiments, THC or another neutral cannabinoid is treated as a designated adulterant marker, exclusion marker, controlled cannabinoid marker, or release-specification marker when absent, non-detected, or present below a selected legal, regulatory, cGMP-compatible, product-category, batch-release, or internal threshold, regardless of whether the THC or other neutral cannabinoid arose naturally, through plant biosynthesis, through decarboxylation, through degradation, through oxidation, through processing, through storage, through handling, through environmental exposure, or through an unknown origin pathway. In many embodiments, THC functions as a controlled cannabinoid marker or designated exclusion marker independent of its formation mechanism, such that the disclosed phytofunctional composition satisfies one or more THC-related release criteria, legal thresholds, regulatory thresholds, or product-category thresholds regardless of whether any THC present originated from unintended decarboxylation of native THCa or from any other source or pathway. In some embodiments, the selected threshold comprises less than about 0.3 weight percent, less than about 0.2 weight percent, less than about 0.1 weight percent, less than about 0.05 weight percent, or a non-detected level as determined by a validated analytical method. In many embodiments, exclusion or control of THC below a selected threshold can support legal compliance, regulatory compliance, cGMP-compatible batch release, product-category designation, interstate commerce eligibility, or combinations thereof independent of the origin pathway of the THC.

In some embodiments, the resulting phytofunctional composition is substantially free of oxidation products. As used herein, “oxidation products” refers to degradation-associated compounds generated through oxygen exposure, heat exposure, storage instability, irradiation, aggressive remediation, oxidative treatment, prolonged transportation, or other processing conditions capable of chemically altering native cannabinoid-acid profiles, terpene profiles, or volatile constituent profiles. In many embodiments, oxidation products function as analytical degradation markers indicating loss of source-linked chemical identity relative to the cannabis source or hemp source. Oxidation-associated profile drift can alter cannabinoid-acid ratios, terpene relationships, chromatographic signatures, spectroscopic signatures, volatile profiles, or combinations thereof. In some embodiments, oxidation products are absent or present below selected analytical thresholds sufficient to preserve source-linked analytical characteristics and maintain cGMP-compatible release-state identity.

In some embodiments, the resulting phytofunctional composition is substantially free of microbial contamination markers, fungal contamination markers, or mycotoxin-associated markers. Such contamination markers can result from improper storage, moisture exposure, environmental contamination, transportation conditions, or inadequate remediation. Exclusion of such markers can improve safety, contamination control, release-state verification, and cGMP-compatible manufacturing.

In many embodiments, the method further comprises generating a certificate of analysis, analytical release report, batch-release record, or chain-of-custody record associated with the resulting phytofunctional composition. Such records can support traceability, analytical verification, release-state designation, contamination control, and cGMP-oriented manufacturing. In many embodiments, such documentation can provide objective evidence that the disclosed dual-condition release criteria have been satisfied.

The disclosed phytofunctional composition can be formulated for oral administration. In many embodiments, the disclosed phytofunctional composition is provided in the form of a capsule, tablet, gel-cap, powder, suspension, or lozenge. In many embodiments, the dosage form preserves a native acidic cannabinoid profile while being substantially free of degradation-generated neutral cannabinoids above a selected threshold. Such dosage forms can support downstream packaging, transportation, storage, and regulated commercialization while maintaining source-linked chemical identity.

In some embodiments, the dosage form excludes tobacco, tobacco-derived material, nicotine-containing material, and tobacco-product components. Exclusion of tobacco and nicotine-containing materials can distinguish the disclosed embodiments from tobacco products, nicotine-delivery systems, combustible tobacco materials, or tobacco-derived formulations and can support distinct regulatory treatment relative to tobacco-associated products.

The disclosed phytofunctional composition can be produced using extraction, dehydration, milling, solvent extraction, concentration, drying, filtration, evaporation, distillation, or combinations thereof. Extraction techniques suitable for use with the disclosed phytofunctional composition include hydroethanolic extraction, ethanol extraction, supercritical carbon dioxide extraction, solvent extraction, dehydration, milling, freeze drying, or combinations thereof.

In some embodiments, the disclosed phytofunctional composition can be produced using an atmospheric triphasic chromatography (ATC) method. As used herein, “ATC-enabled processing” or “atmospheric triphasic chromatography” refers to the atmospheric triphasic chromatography method disclosed in U.S. patent application Ser. No. 17/222,943, filed Apr. 5, 2021, published as U.S. Patent Application Publication No. 2022/0317097 A1 on Oct. 6, 2022, the entire disclosure of which is incorporated herein by reference. The ATC method is an atmospheric-pressure chromatography process that selectively extracts and purifies cannabinoid acids from raw cannabis or hemp plant material without requiring elevated temperatures, vacuum, specialized chromatography equipment, or winterization. The ATC method exploits the natural carboxylic acid group present on native cannabinoid acids to achieve pH-dependent phase separation and selective recovery of target cannabinoid-acid constituents while simultaneously removing decarboxylated cannabinoids, fats, oils, pigments, and other impurities.

In many embodiments, the ATC method comprises introducing raw plant material containing cannabinoids into a non-polar solvent, dissolving cannabinoids extracted from the raw plant material in the non-polar solvent, and removing the raw plant material to obtain a target solution. The non-polar solvent can comprise phenolic, aromatic, or aliphatic hydrocarbons, including straight-chain or isomerized mixtures thereof. Potency analysis and cannabinoid extract profile analysis of the target solution can be performed using HPLC/UV analysis or other analytical techniques to determine the total extracted amount and proportional distribution of cannabinoid constituents.

In many embodiments, the ATC method further comprises preparing an aqueous caustic solution and mixing the target solution with the aqueous caustic solution to obtain a mixture. The mixture separates into a first phase solution comprising a non-polar solvent solution containing decarboxylated cannabinoids, fats, oils, and pigments, and a second phase solution comprising an aqueous caustic solution containing acidic cannabinoids such as THCa, CBDa, and CBGa. The first phase solution is removed to obtain a caustic target solution having a pH between about 12.8 and about 14. In many embodiments, the separation of decarboxylated cannabinoids into the non-polar phase and retention of native cannabinoid acids in the aqueous caustic phase exploits the ionizable carboxylic acid group present on cannabinoid acids, thereby achieving selective separation without thermal decarboxylation.

In many embodiments, the ATC method further comprises differential pH acidification to achieve selective, sequential recovery of individual cannabinoid acids from the caustic target solution. In a first acidification step, the caustic target solution is acidified to a pH within the range of about 10.5 to about 12, thereby selectively precipitating THCa from solution. A non-polar solvent is then mixed with the acidified caustic target solution to dissolve and recover the precipitated THCa. In some embodiments, THCa is itself the target compound recovered from this first acidification step, and the recovered THCa can function as a native source-linked cannabinoid-acid constituent suitable for use in the disclosed phytofunctional compositions. In a second acidification step, the remaining target phase solution is further acidified to a pH from about 1 to about 3, thereby selectively precipitating CBDa as a viscous oil. A non-polar solvent is then introduced to dissolve the precipitated CBDa, and the resulting mixture is separated to recover the CBDa. In some embodiments, CBDa is the target compound recovered from this second acidification step. Solvent removal from either recovered cannabinoid-acid fraction can be performed using rotary evaporation under vacuum at moderate temperatures to protect the integrity of the target compound. In many embodiments, the differential pH selectivity of the ATC method enables sequential isolation of individual cannabinoid acids without thermal decarboxylation, thereby preserving native cannabinoid-acid profiles suitable for use in the disclosed phytofunctional compositions.

In many embodiments, the ATC method is configured to preserve native cannabinoid-acid profiles by operating at atmospheric pressure and at or near room temperature, without requiring winterization, distillation, or other thermal processing steps that can cause unintended decarboxylation, oxidation, or volatilization of native cannabinoid acids and terpenes. In many embodiments, the ATC method can produce cannabinoid-acid oils at purities at or over 80 percent with efficiencies at or over 75 percent while selectively removing decarboxylated cannabinoids, heavy metals, pesticides, and other impurities through pH-dependent phase-separation mechanisms. The resulting cannabinoid-acid compositions produced using the ATC method can function as source-linked phytofunctional compositions preserving native cannabinoid-acid relationships, terpene relationships, and source-linked analytical fingerprints associated with the original cannabis source or hemp source.

In many embodiments, the disclosed phytofunctional composition, whether produced using ATC-enabled processing or any other processing method capable of satisfying the disclosed source-linked preservation criteria, THC-threshold criteria, designated-adulterant exclusion criteria, residual-solvent criteria, and source-authentication criteria, can be analytically characterized, tested, or verified in its finished state to determine whether the composition satisfies the claimed release-state criteria independent of the specific processing method employed. In many embodiments, the analytical characteristics of the finished phytofunctional composition, including preserved source-linked cannabinoid-acid ratios, reduced degradation-generated neutral cannabinoids, residual solvent profiles, terpene-relationship preservation, chromatographic signatures, spectroscopic signatures, or multivariate analytical fingerprints, can function as process-indicative markers, process-authentication markers, or process-verification indicators capable of distinguishing compositions produced using source-preserving processing methods from compositions produced using conventional destructive processing methods, regardless of whether the source-preserving processing method comprises ATC-enabled processing, a modified version of ATC-enabled processing, or another non-thermal, non-destructive processing method configured to satisfy the disclosed preservation and exclusion criteria.

In many embodiments, the disclosed phytofunctional composition claims are directed to the resulting composition state and its analytically verifiable characteristics rather than to the specific processing method used to produce the composition. Accordingly, any processing method, whether comprising ATC-enabled processing, modified ATC-enabled processing, alternative atmospheric-pressure chromatography, alternative pH-dependent separation, alternative non-thermal extraction, or any other processing technique, that produces a composition satisfying the disclosed source-linked preservation criteria, exclusion-marker criteria, THC-threshold criteria, residual-solvent criteria, and source-authentication criteria can produce a composition falling within the scope of the disclosed embodiments. In many embodiments, analytical testing of the finished phytofunctional composition can determine compliance with the claimed composition state without requiring knowledge of or access to the specific processing method employed during manufacturing.

In some embodiments, the disclosed phytofunctional composition is configured to preserve native or source-linked chemical fingerprint characteristics while reducing contamination markers, degradation markers, adulteration markers, and reconstruction markers associated with conventional cannabis and hemp processing techniques.

### EXAMPLES

The following examples are provided to illustrate certain non-limiting embodiments of the disclosed phytofunctional compositions, consumption-safe compositions, and analytical characterization methods. The examples demonstrate preservation of source-linked cannabinoid-acid relationships, terpene relationships, volatile profiles, chromatographic relationships, spectroscopic relationships, or combinations thereof while simultaneously reducing, eliminating, or controlling degradation markers, contamination markers, adulteration markers, reconstruction markers, or combinations thereof associated with conventional cannabis and hemp processing techniques.

### Example 1: Source-Linked Phytofunctional Composition

In one non-limiting embodiment, a cannabis-derived phytofunctional composition was prepared from cannabis flower material configured to preserve source-linked cannabinoid-acid relationships and terpene relationships associated with the original cannabis source material. The resulting phytofunctional composition was configured as a live resin composition possessing preserved native cannabinoid-acid profiles and preserved volatile terpene relationships while reducing degradation-associated transformation products associated with conventional distillate production. Unlike conventional distillate production processes involving extensive pre-consumer decarboxylation, the disclosed phytofunctional composition preserved substantial levels of native acidic cannabinoids present in the original source flower. In many embodiments, the resulting composition remained analytically associated with the original cannabis source while being substantially free of degradation-generated neutral cannabinoids above selected analytical thresholds.

In many embodiments, concentration of native cannabinoid acids within the resulting phytofunctional composition can increase relative to the source flower due to extraction, concentration, solvent removal, or downstream processing while one or more source-linked cannabinoid-acid relationships remain analytically associated with the original cannabis source material. In one example, source flower material and the resulting phytofunctional composition of Example 1 were analyzed using high-performance liquid chromatography (HPLC) analytical techniques. Representative cannabinoid profiles are set forth below in Table 1.

TABLE 1
Representative Source Flower
and Example 1 Cannabinoid Profiles

| | Source | Example 1 |
|---|---|---|
| Cannabinoid | Flower (% wt.) | (% wt.) |
| THCa | 12.01 | 73.29 |
| Δ⁹-THC | 0.86 | 8.12 |
| THCVa | 0.19 | 0.80 |
| CBGa | 0.26 | 1.14 |
| Total Cannabinoids | 13.32 | 83.35 |

In many embodiments, tetrahydrocannabinolic acid (THCa) functions as a native acidic cannabinoid and source-linked cannabinoid-acid constituent associated with the original cannabis source material. Likewise, tetrahydrocannabivarinic acid (THCVa) and cannabigerolic acid (CBGa) can function as source-linked minor cannabinoid-acid constituents associated with cultivar-linked, chemotype-linked, or source-linked analytical relationships present in the source flower. A9-tetrahydrocannabinol (49-THC) can function as both a native neutral cannabinoid and a degradation-associated decarboxylation marker when formed through unintended pre-consumer decarboxylation of corresponding cannabinoid acids. In many embodiments, preservation of relative THCa, A9-THC, THCVa, and CBGa relationships between the source flower and the resulting phytofunctional composition of Example 1 functions as an analytical indicator that the resulting phytofunctional composition remains source-linked and chemically associated with the original cannabis source material despite extraction, concentration, formulation, transportation, storage, remediation, or downstream processing. Such cannabinoid-acid relationships can therefore function as representative source-linked analytical relationships, cannabinoid-acid profiles, multivariate analytical relationships, or combinations thereof associated with the original cannabis source or hemp source.

Using THCa as the first organic acid (A1), the source-linked analytical relationships between THCa and the minor cannabinoid acids THCVa and CBGa were evaluated according to the ratio-preservation framework described in claim 5. In addition, the analytical relationship between THCVa and CBGa was evaluated to determine preservation of relative minor-cannabinoid-acid relationships within the resulting phytofunctional composition. For each comparison, the source-flower ratio (RS) was calculated by dividing the concentration of the first cannabinoid acid present in the source flower by the concentration of the second cannabinoid acid present in the source flower. The corresponding phytofunctional-composition ratio (RC) was calculated using the concentrations present in the resulting phytofunctional composition. The percent change between RS and RC was then calculated according to the formula |RC−RS|=RS×100.

TABLE 2
Representative Source-Linked
Cannabinoid-Acid Ratio Preservation Analysis

| Analytical | Source | | |
|---|---|---|---|
| Relationship | Flower | Example 1 | Percent |
| (A1:A2) | Ratio (RS) | Ratio (RC) | Change |
| THCa:THCVa | 12.01 ÷ 0.19 = 63.21 | 73.29 ÷ 0.80 = 91.61 | 44.9% |
| THCa:CBGa | 12.01 ÷ 0.26 = 46.19 | 73.29 ÷ 1.14 = 64.29 | 39.2% |
| THCVa:CBGa | 0.19 ÷ 0.26 = 0.73 | 0.80 ÷ 1.14 = 0.70 | 4.1% |

These analytical comparisons demonstrate that the THCa:THCVa, THCa:CBGa, and THCVa:CBGa relationships remained directionally associated with the original cannabis source material and that the corresponding acidic cannabinoid constituents were preserved within the resulting phytofunctional composition following extraction and downstream processing. The THCa:THCVa and THCa:CBGa relationships exhibited calculated percent changes of approximately 44.9% and 39.2%, respectively, satisfying the representative “less than about 50%” threshold disclosed in claim 5. In contrast, the THCVa:CBGa relationship exhibited a calculated percent change of approximately 4.1%, thereby demonstrating substantially greater preservation of the relative analytical relationship between the minor cannabinoid acids THCVa and CBGa across the source flower and the resulting phytofunctional composition. In many embodiments, lower percent-change values can indicate reduced analytical drift and increased preservation of source-linked cannabinoid-acid relationships associated with the original cannabis source material.

Without being bound by theory, the substantially lower percent-change value observed for the THCVa:CBGa ratio (approximately 4.1%) relative to the THCa:THCVa and THCa:CBGa ratios (approximately 44.9% and 39.2%, respectively) is believed to result from the similar physicochemical properties and co-extraction behavior of minor cannabinoid-acid constituents. Both THCVa and CBGa are present at comparable trace concentrations in the source flower (0.19% and 0.26%, respectively), possess similar molecular weight ranges, exhibit comparable polarity and functional-group architecture, and are believed to co-localize within the same trichome compartments of the cannabis source material. As a result, THCVa and CBGa are expected to exhibit substantially similar solubility characteristics, matrix-binding behavior, and extraction efficiency during downstream processing, thereby concentrating at nearly identical rates and maintaining their relative ratio across source and output compositions. In contrast, ratios involving a dominant cannabinoid acid such as THCa paired with a minor cannabinoid acid can exhibit greater percent-change values because differences in extraction dynamics between high-abundance and trace-level constituents are amplified by the dominant acid's disproportionate concentration. Accordingly, minor-to-minor cannabinoid-acid ratios represent a preferred analytical embodiment for satisfying narrower source-to-output ratio thresholds, including percent-change values satisfying the representative “less than about 5%” threshold disclosed in claim 5, because such ratios can be more resistant to concentration-dependent drift during extraction, concentration, formulation, or downstream processing.

In many embodiments, preservation of relative cannabinoid-acid relationships between the source flower and the resulting phytofunctional composition of Example 1 functioned as an analytical indicator that the resulting composition remained source-linked and chemically associated with the original cannabis source material despite extraction, concentration, formulation, or downstream processing. Representative preservation relationships are set forth below in Table 3.

TABLE 3
Representative Source-Linked Analytical Relationship Comparison

| Analytical | Source | Example | |
|---|---|---|---|
| Relationship | Flower | 1 | Representative Observation |
| THCa-dominant | Present | Present | Source-linked acidic cannabinoid |
| cannabinoid profile | | | relationship maintained |
| Acid-to-neutral | THCa > | THCa > | Reduced pre-consumer |
| cannabinoid | THC | THC | decarboxylation relative to |
| relationship | | | Comparative Example 1 |
| THCVa profile | Present | Present | Source-linked minor cannabinoid |
| | | | relationship maintained |
| CBGa profile | Present | Present | Source-linked cannabinoid-acid |
| | | | relationship maintained |
| Broad-spectrum | Present | Present | Analytical similarity associated |
| acidic cannabinoid | | | with source-linked cannabinoid- |
| composition | | | acid preservation |

In some embodiments, graphical comparison of source-linked cannabinoid relationships can further demonstrate preservation of native cannabinoid-acid profiles within the disclosed phytofunctional composition relative to the original cannabis source material. As illustrated in FIG. 2, representative analytical comparison of THCa, A9-THC, THCVa, and CBGa relationships between source flower material and the phytofunctional composition of Example 1 demonstrates preservation of source-linked cannabinoid-acid relationships despite extraction, concentration, formulation, or downstream processing. In many embodiments, THCa remains the dominant cannabinoid constituent in both the source flower and the resulting phytofunctional composition, thereby indicating reduced unintended pre-consumer decarboxylation relative to Comparative Example 1. In many embodiments, preservation of source-linked acidic cannabinoid dominance can function as an analytical indicator that the disclosed phytofunctional composition remains chemically associated with the original cannabis source material while remaining analytically distinguishable from conventional THC-dominant distillate formulations.

FIG. 2A illustrates lab testing results conducted by PSI Labs (3970 Varsity Dr, Ann Arbor, MI 48108; ISO/IEC 17025:2017 Accreditation No. 84351). The source flower sample (Sample ID: 2202PSI0058.01672; Flower—Cured; MMFLA License No. SC-000005) cannabinoid testing was completed using HPLC-DAD methodology (SOP-PSIMTDA). The live resin sample corresponding to Example 1 (Sample ID: 2202PSI0123.01919; Concentrates & Extracts; MMFLA License No. AU-SC-000100) cannabinoid testing was completed using the same HPLC-DAD methodology. The live resin sample passed all additional safety testing categories, including residual solvents (GC-MS), microbials (3M Petrifilm), pesticides (HPLC-MS/MS), heavy metals (ICP-MS), and foreign matter (visual examination). The lab testing results set forth in FIG. 2A confirm the cannabinoid profile data presented in Table 1 and FIG. 2 and further support preservation of source-linked cannabinoid-acid relationships within the resulting phytofunctional composition of Example 1.

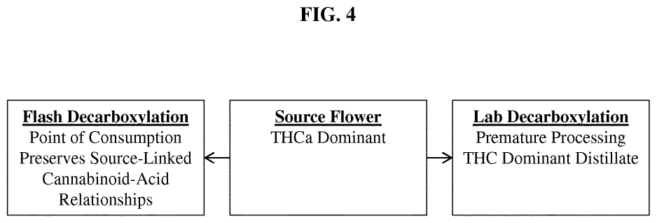

FIG. 4 illustrates a representative comparison between flash decarboxylation occurring at the point of consumer use and processing-associated lab decarboxylation occurring during conventional distillate production. In many embodiments, flash decarboxylation can preserve source-linked cannabinoid-acid relationships and terpene relationships until the point of consumption, thereby allowing native acidic cannabinoids and volatile constituents to remain associated with the original cannabis source or hemp source prior to end-user transformation. In contrast, conventional lab decarboxylation can prematurely convert native cannabinoid acids into corresponding neutral cannabinoids during downstream processing, thereby altering source-linked analytical relationships and increasing degradation-associated analytical drift. In many embodiments, FIG. 4 illustrates the distinction between the disclosed phytofunctional compositions and conventional THC-dominant distillate compositions referenced in Comparative Example 1 and the associated claims directed to reduced degradation-generated neutral cannabinoids, preserved source-linked analytical identity, and reduced unintended pre-consumer decarboxylation.

### Comparative Example 1: Conventional Distillate Composition

Comparative Example 1 represents a conventional distillate-based cannabis composition produced using conventional distillate manufacturing processes involving substantial pre-consumer decarboxylation of native cannabinoid acids during processing. Conventional distillate production frequently converts substantial portions of THCa and other acidic cannabinoids into corresponding neutral cannabinoids prior to consumer use, thereby reducing preservation of source-linked cannabinoid-acid relationships and volatile terpene relationships associated with the original cannabis source material. In many embodiments, conventional distillate compositions can further include terpene supplementation, isolate spiking, profile reconstruction, dilution, or addition of exogenous constituents. In many embodiments, conventional distillate compositions are characterized by THC-dominant cannabinoid profiles formed through extensive processing-associated decarboxylation of native cannabinoid acids during production.

Representative distinctions between Comparative Example 1 and the phytofunctional composition of Example 1 are summarized below in Table 4.

TABLE 4
Representative Comparison Between
Comparative Example 1 and Example 1

| | Comparative | |
|---|---|---|
| Characteristic | Example 1 | Example 1 |
| Primary cannabinoid form | THC-dominant | THCa-dominant |
| Premature lab decarboxylation | Extensive | Reduced |
| Preservation of source-linked | Reduced | Preserved |
| cannabinoid-acid relationships | | |
| Preservation of terpene | Often reduced | Preserved |
| relationships | | |
| Reconstruction/terpene | Common | Reduced or |
| supplementation | | absent |
| Source-linked analytical identity | Often altered | Preserved |
| Broad-spectrum raw cannabinoid | Reduced | Preserved |
| profile | | |

In many embodiments, laboratory analysis can distinguish the phytofunctional composition of Example 1 from Comparative Example 1 through preservation of source-linked acidic cannabinoid relationships, reduced pre-consumer decarboxylation, preservation of minor cannabinoid-acid constituents, and preservation of source-linked analytical identity associated with the original cannabis source material.

In some embodiments, the phytofunctional composition of Example 1 was configured as a cGMP-compatible consumption-safe composition suitable for incorporation into vaporizer cartridges, inhalable products, compounding compositions, downstream manufacturing compositions, formulation-ready intermediates, or incorporation-ready consumer products. In many embodiments, the resulting compositions preserved source-linked analytical relationships while remaining substantially free of degradation-generated neutral cannabinoids, contamination markers, adulteration markers, reconstruction markers, or combinations thereof associated with naturally occurring source material, downstream processing, or artificial profile reconstruction.

The disclosed embodiments provide advantages over conventional remediation, purification, decontamination, extraction, and profile reconstruction processes by preserving source-linked cannabinoid-acid relationships, terpene relationships, chromatographic profiles, spectroscopic profiles, volatile profiles, or combinations thereof within selected analytical tolerances while simultaneously supporting contamination control, anti-reconstitution verification, traceability, analytical verification, and cGMP-compatible batch release.

The terms “comprising” or “comprise” are used herein in their broadest sense to mean and encompass the notions of “including,” “include,” “consist(ing) essentially of,” and “consist(ing) of.” The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples. The term “about” as used herein serves to reasonably encompass or describe minor variations in numerical values measured by instrumental analysis or as a result of sample handling. Such minor variations may be in the order of +0-10, +0-5, or +0-2.5, % of the numerical values. Further, the term “about” applies to both numerical values when associated with a range of values. Moreover, the term “about” may apply to numerical values even when not explicitly stated.

Generally, as used herein a hyphen “-” or dash “-” in a range of values is “to” or “through”; a “>” is “above” or “greater-than”; a “>” is “at least” or “greater-than or equal to”; a “<” is “below” or “less-than”; and a “<” is “at most” or “less-than or equal to.” On an individual basis, each of the aforementioned applications for patent, patents, and/or patent application publications, is expressly incorporated herein by reference in its entirety in one or more non-limiting embodiments.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The present invention has been described herein in an illustrative manner, and it is to be understood that the terminology that has been used is intended to be in the nature of words of description rather than of limitation. Many modifications and variations of the present invention are possible in light of the above teachings. The present invention may be practiced otherwise than as specifically described within the scope of the appended claims. The subject matter of all combinations of independent and dependent claims, both single and multiple dependent, is herein expressly contemplated.

1. A cGMP-compatible phytofunctional composition formed from a cannabis source or a hemp source, the phytofunctional composition comprising:
(A) a plurality of native organic acids from the cannabis source or hemp source, wherein the plurality of native organic acids can degrade, decarboxylate, decompose, oxidize, or transform when exposed to elevated temperatures during extraction, drying, formulation, storage, transportation, or processing;
(B) one or more native terpenes from the cannabis source or hemp source that can degrade, decarboxylate, decompose, oxidize, volatilize, or transform during extraction, drying, formulation, storage, transportation, or processing; and optionally,
(C) a solvent; wherein one or more ratios between the plurality of native organic acids present in the cannabis source or hemp source and one or more corresponding ratios between the plurality of native organic acids present in the phytofunctional composition are substantially similar;
wherein one or more source-linked cannabinoid profiles, cannabinoid-acid profiles, terpene profiles, chromatographic profiles, spectroscopic profiles, volatile profiles, or combinations thereof are preserved within a selected analytical tolerance; and
wherein the phytofunctional composition is substantially free of: degradation-generated neutral cannabinoids, decarboxylated byproducts, oxidation products, decomposition products, microbial contamination, mold, mildew, fungus, spores, mycotoxin-associated markers, aflatoxin-associated markers, pesticides, heavy metals, residual solvents, exogenous cannabinoids, exogenous terpenes, cannabinoid isolate spikes, terpene isolate spikes, diluents, cutting agents, carrier oils, masking agents, reconstructed profile markers, or combinations thereof.

2. The phytofunctional composition of claim 1, wherein the phytofunctional composition simultaneously:
(A) preserves one or more source-linked cannabinoid-acid relationships, terpene relationships, volatile constituent profiles, chromatographic profiles, spectroscopic profiles, mass spectrometric profiles, multivariate analytical relationships, or combinations thereof associated with the cannabis source or hemp source; and
(B) reduces, eliminates, or controls one or more degradation markers, contamination markers, adulteration markers, reconstruction markers, or combinations thereof associated with naturally occurring source material or downstream processing;
wherein the phytofunctional composition possesses analytically verifiable characteristics distinct from naturally occurring cannabis-derived or hemp-derived source material and is analytically distinguishable from conventionally remediated material, purified material, diluted material, isolate-spiked material, re-terpenated material, reconstructed material, or artificially reformulated cannabis-derived or hemp-derived material.

3. The phytofunctional composition of claim 1, wherein the cannabis source comprises Cannabis sativa L., Cannabis indica, Cannabis ruderalis, or hybrids thereof.

4. The phytofunctional composition of claim 1, wherein the plurality of native organic acids comprises one or more cannabinoid acids selected from the group consisting of tetrahydrocannabinolic acid (THCa), cannabidiolic acid (CBDa), cannabigerolic acid (CBGa), cannabichromenic acid (CBCa), tetrahydrocannabivarinic acid (THCVa), cannabidivarinic acid (CBDVa), cannabinolic acid (CBNa), and combinations thereof.

5. The phytofunctional composition of claim 4, wherein:
the plurality of native organic acids includes at least a first organic acid (A1) and a second organic acid (A2);
a weight ratio of (A1):(A2) present in the phytofunctional composition (RC) is calculated by dividing a total weight of (A1) present in the phytofunctional composition by a total weight of (A2) present in the phytofunctional composition;
a weight ratio of (A1):(A2) present in the cannabis source or hemp source (RS) is calculated by dividing a total weight of (A1) present in the cannabis source or hemp source by a total weight of (A2) present in the cannabis source or hemp source; and
wherein a percent change between (RS) and (RC) is less than about 50%; and, optionally,
wherein when (A1) and (A2) each independently comprise a minor cannabinoid acid present at a concentration of less than about 5 weight percent in the cannabis source or hemp source, the percent change between (RS) and (RC) is less than about 5%.

6. The phytofunctional composition of claim 1, wherein one or more neutral cannabinoids formed from unintended pre-consumer decarboxylation of the plurality of native organic acids are absent or present below a selected threshold.

7. The phytofunctional composition of claim 6, wherein tetrahydrocannabinol (THC) is absent, not detected, or present below a selected legal, regulatory, cGMP-compatible, product-category, batch-release, or internal threshold, regardless of whether the THC arose naturally, through plant biosynthesis, through decarboxylation, through degradation, through oxidation, through processing, through storage, through handling, through environmental exposure, or through an unknown origin pathway.

8. The phytofunctional composition of claim 1, wherein the selected analytical tolerance comprises less than about 20% deviation from the cannabis source or hemp source, or wherein the phytofunctional composition exhibits a multivariate similarity score of at least about 0.80 relative to the cannabis source or hemp source, or both.

9. The phytofunctional composition of claim 1, wherein the one or more native terpenes comprise one or more terpenes selected from the group consisting of β-myrcene, limonene, α-pinene, β-pinene, linalool, terpinolene, ocimene, humulene, β-caryophyllene, nerolidol, and combinations thereof, and wherein the phytofunctional composition is substantially free of exogenous terpenes not originally present in the cannabis source or hemp source and substantially free of terpene isolate spikes inconsistent with the cannabis source or hemp source.

10. The phytofunctional composition of claim 1, wherein the primary source-linked analytical characteristics preserved within the selected analytical tolerance comprise one or more cannabinoid-acid profiles, raw cannabinoid profiles, acid-to-neutral cannabinoid relationships, cannabinoid-acid ratios, chromatographic cannabinoid profiles, spectroscopic profiles, mass-spectrometric profiles, or multivariate cannabinoid-dominant analytical fingerprints, and wherein preservation of terpene profiles, volatile profiles, or terpene-ratio relationships is not required unless expressly selected as a release criterion.

11. The phytofunctional composition of claim 1, wherein the phytofunctional composition satisfies one or more cGMP-compatible batch-release specifications comprising preservation of one or more source-linked cannabinoid-acid profiles and exclusion of one or more exclusion markers.

12. The phytofunctional composition of claim 1, wherein continued conformity of the phytofunctional composition with one or more release-state criteria is verifiable by analytical testing, wherein the phytofunctional composition possesses a pH from about 6.0 to about 7.2, and wherein the phytofunctional composition optionally comprises heptane as a solvent.

13. A tablet, gel-cap, capsule, pill, powder, solution, suspension, lozenge, or packaged dosage form comprising the phytofunctional composition of claim 1.

14. A finished cGMP-compatible phytofunctional composition formed from a documented cannabis source or documented hemp source, the finished phytofunctional composition comprising a plurality of native cannabinoid acids or native organic acids from the cannabis source or hemp source, wherein the documented cannabis source or documented hemp source is associated with source-fingerprint data and the finished phytofunctional composition is associated with output-fingerprint data;
wherein one or more source-linked cannabinoid-acid profiles, raw cannabinoid profiles, acid-to-neutral cannabinoid relationships, chromatographic profiles, spectroscopic profiles, mass-spectrometric profiles, multivariate analytical profiles, or combinations thereof are preserved within a selected analytical tolerance relative to the source-fingerprint data associated with the documented cannabis source or documented hemp source; and
wherein THC is absent, non-detected, or present below a selected release threshold; wherein residual processing solvent is absent, non-detected, or present below a selected residual-solvent release threshold; wherein the finished phytofunctional composition is substantially free of one or more designated adulterants, undocumented plant-source inputs, non-source-matching cannabinoids, cannabinoid isolate spikes, contamination markers, degradation markers, oxidation products, reconstructed profile markers, or combinations thereof; and wherein the finished phytofunctional composition is analytically consistent with the documented cannabis source or documented hemp source based on comparison of the source-fingerprint data and the output-fingerprint data.

15. The finished phytofunctional composition of claim 14, wherein the source-fingerprint data and output-fingerprint data are compared using mass-balance, yield-plausibility, ratio-preservation, set-membership, chromatographic correlation, spectral similarity, multivariate similarity, or combinations thereof.

16. The finished phytofunctional composition of claim 14, wherein the finished composition is associated with a certificate of analysis, analytical release report, batch-release record, source-fingerprint record, finished-product fingerprint record, yield-plausibility record, or chain-of-custody record.

17. The finished phytofunctional composition of claim 14, wherein the finished phytofunctional composition is produced using atmospheric triphasic chromatography (ATC)-enabled processing, or is produced by a process other than ATC and nevertheless satisfies the source-linked preservation criteria, THC-threshold criteria, designated-adulterant exclusion criteria, residual-solvent criteria, and source-authentication criteria.

18. The finished phytofunctional composition of claim 14, wherein the composition comprises one or more recorded cGMP-compatible terpene additions that do not materially alter the selected cannabinoid-acid fingerprint, THC-threshold criterion, designated-adulterant exclusion criterion, residual-solvent criterion, or source-authentication criterion, and wherein the composition is substantially free of undisclosed terpene isolate spikes, unrecorded exogenous terpene additions, reconstructed aroma signatures, or terpene-profile engineering inconsistent with a batch record or selected source-authentication criterion.

19. A method of characterizing or releasing a cGMP-compatible phytofunctional composition formed from a cannabis source or a hemp source, the method comprising:
obtaining source-fingerprint data from an identifiable cannabis source or hemp source; obtaining output-fingerprint data from a resulting phytofunctional composition;
comparing the source-fingerprint data and the output-fingerprint data to determine preservation of one or more source-linked cannabinoid profiles, cannabinoid-acid profiles, terpene profiles, volatile profiles, chromatographic profiles, spectroscopic profiles, or combinations thereof;
testing the resulting phytofunctional composition for one or more degradation markers, decarboxylation markers, microbial contaminants, fungal contaminants, pesticide residues, heavy metals, residual solvents, exogenous terpenes, exogenous cannabinoids, isolate spikes, or reconstructed profile markers; and
designating the resulting phytofunctional composition as a cGMP-compatible release-state phytofunctional composition only when: (A) one or more source-linked cannabinoid profiles, cannabinoid-acid profiles, terpene profiles, volatile profiles, chromatographic profiles, spectroscopic profiles, or combinations thereof are preserved within a selected analytical tolerance; and (B) one or more contaminants, degradation markers, adulteration markers, or reconstruction markers satisfy one or more exclusion criteria.

20. The method of claim 19, wherein the comparing step comprises determining ratio drift between source-linked cannabinoid-acid ratios and output cannabinoid-acid ratios or determining set-membership preservation; wherein the resulting phytofunctional composition is substantially free of degradation-generated THC; and further comprising generating a certificate of analysis, analytical release report, batch-release record, or chain-of-custody record associated with the resulting phytofunctional composition.
